(19) United States
(12) Patent Application Publication
(10) Pub. No.: US 2025/0339900 A1
(43) Pub. Date: Nov. 6, 2025

(54) PROCESS OF FORMING A CUTTING TOOL WITH ADDITIVELY DEPOSITED CUTTING EDGE

(71) Applicant: COMMONWEALTH SCIENTIFIC AND INDUSTRIAL RESEARCH ORGANISATION, Acton, Australian Capital Territory (AU)

(72) Inventors: Dayalan Romesh GUNASEGARAM, Mt Waverley, Victoria (AU); Nazmul ALAM, Narre Warren South, Victoria (AU); Hansjoerg LOHR, Clayton South, Victoria (AU); Konstantinos FILIPPOU, Clayton South, Victoria (AU); Teresa KITTEL, Clayton South, Victoria (AU); Jimmy Timothy TOTON, Bayswater, Victoria (AU)

(21) Appl. No.: 18/866,480

(22) PCT Filed: Apr. 26, 2023
(86) PCT No.: PCT/AU2023/050337

§ 371 Date: Nov. 15, 2024

(30) Foreign Application Priority Data
May 17, 2022 (AU) 2022901322

(51) Int. Cl. B22F 12/82; B22F 5/00; B22F 10/25; B22F 10/66; B23P 15/28; B33Y 10/00; B33Y 40/20; B33Y 70/10; B33Y 80/00

(52) U.S. Cl. CPC B22F 12/82; B22F 10/25; B22F 10/66; B23P 15/28; B22F 2005/001; B33Y 10/00; B33Y 40/20; B33Y 70/10; B33Y 80/00

(57) ABSTRACT

The present invention provides a process of forming a cutting tool comprising the steps of: additive deposition of a tool material comprising at least one of: tungsten carbide, TaNbC, a tungsten carbide containing alloy or composite, or a TaNbC containing alloy or composite onto a base substrate having a longitudinal axis, said tool material being deposited onto the base substrate to form a deposit body configured to form at least one cutting formation therein; and subsequently subtracting selected portions of the deposit body to produce at least one cutting formation having a selected cutting edge configuration, thereby forming the cutting tool.

### PRIORITY CROSS-REFERENCE

The present application claims priority from Australian provisional patent application No. 2022901322 filed on 17 May 2022, the contents of which should be understood to be incorporated into this specification by this reference.

### TECHNICAL FIELD

The present invention relates to a process of forming cutting tools using the combination of additive manufacturing and subtractive manufacturing. The invention is particularly applicable to forming cutting or machining tools having hard cutting edges and it will be convenient to hereinafter disclose the invention in relation to that exemplary application. However, it is to be appreciated that the invention is not limited to that application and could be used in a number of cutting or machining tools, as well as other types of tools and equipment where hard surfaces are necessary and/or beneficial for improved wear performances, for example, hardfacing tools and surfaces in mining and resources, wood processing, agriculture, pulp and paper, general engineering, cement, steel and aluminium, printing, bulk and materials handling, quarries, and oil and gas.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Cutting tools are used in a variety of subtractive manufacturing applications to cut, grind, shape or otherwise remove material from a workpiece to form a desired product configuration. Cutting tools generally comprise a cylindrical blank configured to be fastened in a cutting machine, and a cutting head that includes the cutting edges. The cutting edges are sharp, hard edges configured to contact and remove material from the work substrate.

One of the common methods of manufacturing industrial metal cutting tools involves grinding a solid cylindrical blank of high speed steel (HSS) or tungsten carbide (WC) to create the desired cutting edge configurations in the cutting head of the cutting tool. However, this method requires the entire cutting tool to be formed from the higher cost high hardness, high strength and high wear resistance material required for the cutting edges.

Cost can be reduced by forming the cutting edges in cutting formations using a material or combination of materials comprising the requisite high hardness, high strength and high wear resistance and mounting those cutting formations onto a lower cost material, such as a relatively low cost cylindrical steel blank. Conventionally, this type of cutting tool can be formed by firstly brazing, using manual labour, a sintered insert that is made of a hard material such as tungsten carbide onto a cylindrical blank; this intermediate part is subsequently ground to create the cutting edges and flutes required on the cutting tool.

Brazing can be a costly and time-consuming process for making composite tools. It would therefore be desirable to provide a method that automates the production of this type of composite cutting tool by removing the need to manually braze an insert onto a blank.

### SUMMARY OF THE INVENTION

The present invention provides a process (method) of forming a cutting tool that combines an additive process with a subtractive manufacturing process such as (but not limited to) grinding.

A first aspect of the present invention provides a process of forming a cutting tool comprising the steps of:
additive deposition of a tool material comprising tungsten carbide, TaNbC, a tungsten carbide containing alloy or composite, or a TaNbC containing alloy or composite onto a base substrate having a longitudinal axis, said tool material being deposited onto the base substrate to form a deposit body configured to form at least one cutting formation therein; and
subsequently subtracting selected portions of the deposit body to produce at least one cutting formation having a selected cutting edge configuration, thereby forming the cutting tool.

The present invention therefore provides an innovative two-step manufacturing process in which the material forming the cutting edge or edges of a cutting tool are additively deposited on a base substrate, typically a cylindrical metal blank, and a portion of that deposited material is then subtractively machined, for example undergoes grinding, to form the final desired and designed cutting edge configuration of the cutting tool. The subtractive step forms the final shape of the cutting tool. The additive manufacturing—subtractive machining steps can include automated steps, and in some forms the process may comprise a fully automated process.

The additive deposition process preferably comprises a blown powder type additive manufacturing process/system, also known as directed energy deposition (DED). In exemplary embodiments, the additive deposition process comprises at least one of: laser metal deposition (LMD) process, direct metal deposition (DMD), or other types of DED processes. It should be appreciated that DED process is known by other names, including Laser Engineered Net Shaping (LENS), Direct Metal Deposition (DMD), Electron Beam Additive Manufacturing (EBAM), Directed Light Fabrication, and 3D Laser Cladding, depending on the exact application or method used.

It should be understood that a directed energy deposition (DED) process uses a heat source, such as an electron beam or a laser beam to heat up the workpiece locally, creating a melt (weld) pool. Fine metal powder is then fed into the melt pool from a powder feed nozzle where the powder melts and combines with the base material forming a deposition layer, which, when solidified, fuses the materials together, typically having a layer thickness of 0.2 to 1 mm. The process can be repeated to build a desired shape, in this case a cutting formation and associated cutting tool configuration, using a sequence of deposit layer built upon each other. A three-dimensional shape can be built up on the substrate by relatively moving the laser beam and powder feed nozzle and the substrate to apply lines, areas, and shapes. The powder feed nozzle, can be attached to the laser optics or can be configured to move synchronously with the laser optics. Similarly, the laser beam can pass through the centre of powder feeding nozzle or through standalone optics. The powder feed nozzle and laser optics can be mounted on a multi axis arm (together or separately), typically a robotic arm, which can move in multiple directions, allowing for variable deposition. Here, the object can remain in a fixed position while the arm moves to lay down the material. However, this can be reversed with the use of a platform, which moves while the arm remains stationary. Deposition shape and thickness can be controlled by a control system linked to one or more sensors monitor the deposit, powder feed rate, temperature and the like.

The process of the present invention can be used for near-net-shape manufacturing of a cutting tool. In such embodiments, the depositing step is preferably conducted to provide a near-net shape deposit, where the dimensions of the deposit generally match the desired shapes of the cutting tool. Here, the deposit body preferably comprises (slightly exceeds) a near-net shape of the cutting edge in at least one cutting formation. The subtracting step (subtractive machining step) then refines the shape and produces the sharp cutting edges of the cutting formation.

The cutting formation can have any shape or configuration that includes a sharp cutting edge in a cutting tool. That shape and configuration depends on the type and nature of the cutting tool that is being produced. The cutting tool of the present invention can comprise at least one of a cutter, milling cutter, power skiving cutter, annular cutter or drill. To form such cutting tools, the cutting formation can include at least one flute, blade, protrusion, ledge, ramp, depression, channel or the like.

In some embodiments, the deposit body comprises at least one flute deposited in a spiral or helical path on the base substrate. The spiral or helical path follows the shape of the flute and cutting edge of the flute and comprising cutting edge of the desired cutting tool configuration. However, it should be appreciated that various other flute configurations could be used depending on the type and nature of the cutting tool that is being produced.

Near net shape geometry of the cutting formations, such as cutting edges or teeth, can be achieved through the balance of heat input from the heat source (for example a laser) used in the additive deposition step and tool path control and programming for the specific configuration of the cutting formations. The near net shape of the cutting formations is formed from tailored tool path programming directed to the specific shape and configuration of the cutting formations in which the tool material is deposited to form layers or tracks to create a near net shape over the base substrate, for example a tool blank or body. A portion of the deposited mass forms the cutting edge/s of the tool after the subtracting step. The tool path programming is preferably tuned to achieve an optimal energy power density suitable for desired microstructures with minimal defects such as porosity and cracking on the deposited hard material.

In other embodiments, the deposit body is deposited into a general shape around the base substrate, which can then be shaped by the subtractive step, preferably subtractive machining, to form the desired shape of the cutting formations and cutting edges thereof. For example, the deposit body may comprise a substantially cylindrically shaped body. That cylindrically shaped body is deposited to a size and shape that includes/accommodates the cutting formations and cutting edges thereof. Again, tailored tool path programming is used to direct the deposition of tool material on the base substrate to form the cylindrically shaped body. In some embodiments, the deposit body is deposited at and/or around an end surface of the base substrate. These deposit body sections can be used to provide an end section of the cutting tool, for example endface teeth of a cutting tool such as an annular cutter and square end mill.

The tool material comprises a tungsten carbide, TaNbC, or a tungsten carbide or TaNbC containing alloy or composite composition to provide the hard material required for the cutting edge of the cutting formation. The tool material preferably has a composition that comprises a metal matrix composite comprising at least one of WC or TaNbC (being the hard material), together with at least one of Co, or Ni (being the binder material). In embodiments, at least the top deposit layer is formed from a material composition (hard composition) comprising at least one of WC, TaNbC, or a metal matrix composite comprising at least one of WC or TaNbC, together with at least one of Co or Ni. It should be appreciated that the Co or Ni functions as a binder material (the matrix) in that metal matrix composite. In embodiments, the tool material could comprise one of: WC and Co/Ni; TaNbC and Co/Ni; WC and TaNbC and Co/Ni; or metal matrix composite including WC or TaNbC and Co/Ni.

The deposition process can include an in-situ alloying process which creates new metallurgical phases resulting from high temperature reactions between the constituents of the powder mixes. The in-situ alloying techniques can be configured to form new alloys which deliver hard microstructures suitable for cutting tools. For in-situ alloying, the powders comprising the desired alloy may be mixed mechanically offline before being deposited. In some embodiments, thermal spray grade tungsten carbide powder (88WC-12Co of 5 to 20 μm) can be alloyed in-situ with a highly alloyed steel powder, for example a martensitic matrix iron alloy with fine scale, extremely hard molybdenum borides and vanadium carbides with a particle size range of 53 to 150 μm (Metco 1030A). In some embodiments, in-situ alloying occurred between the matrix material and introduced hard material such as WC agglomerates. In other embodiments, the matrix materials and hard material can be deposited separately.

In some embodiments, the tool material comprises at least two material compositions comprising an inner matrix material and a hard material which is deposited over the inner matrix material. The inner matrix material is preferably used usually to bind the hard material, and acts as an intermediary material between the hard material and the base substrate. The inner matrix material preferably forms the desired shape and configuration of the cutting formation (for example cutting tooth/teeth) and the hard material forms the material of the cutting edge thereof. The inner matrix material is preferably selected as a material that is sufficiently hard, such as Metco 1030A, and is used for the inner layers (or intermediate layers—i.e. located between the base substrate and an outer layer) deposited onto the base substate. The inner matrix material can comprise a single material, or could include a mixture of material, for example including hard particles such as WC. The hard material is deposited only onto the inner matrix material as the top deposited layers. Preferably, at least one layer of the inner matrix material and at least one layer of the hard material is additively deposited. However, it should be appreciated that two or more layers of either the inner matrix material or the hard material could be deposited. In some embodiments, at least one layer of the inner matrix material and/or the hard material is deposited.

In embodiments, the inner matrix material comprises a martensitic iron alloy with molybdenum boride and vanadium carbide; or a metal matrix composite comprising WC with at least one of Ni, Cr, Si or B. In some embodiments, the inner matrix material comprises a metal matrix composite that comprises WC in a NiCrSiB or NiSiB matrix. In embodiments, the hard material comprises at least one of WC, TaNbC, or a metal matrix composite comprising at least one of WC or TaNbC, together with at least one of Co or Ni. It should be appreciated that the Co or Ni functions as a binder material (the matrix) in that metal matrix composite. In some embodiments, the hard material comprises at least one of WC, WC-6Co, WC-12Co, WC-6Ni or TaNbC. In preferred embodiments, the inner matrix material comprises a martensitic iron alloy with molybdenum boride and vanadium carbide; and the hard material comprises WC-12Co.

For deposition, that composition is preferably in a powder form. In embodiments, the inner matrix material has a particle size of from 50 to 200 μm, preferably from 53 to 150 μm, and the hard material has a particle size of from 5 to 50 μm, preferably from 5 to 20 μm.

The formed cutting tool includes one or more cutting edges preferably formed with an outer hard layer comprising or substantially comprising the hard material. This typically requires the hard material to be deposited in the deposit body at or around the location that the cutting edge will be produced in the at least one cutting formation. In embodiments, the hard material is deposited over the inner matrix material (when forming the deposit body) in locations in the deposit body which are biased towards a cutting edge or edges of the at least one cutting formation. Preferably, the hard material is deposited in the deposit body at and around the intended shape and/or configuration of the cutting edge or edges of the at least one cutting formation. The subtractive step therefore subtracts material to form that cutting edge from that hard material only. This ensures that the cutting tool preferably provides a cutting edge with a hardness corresponding only to, or substantially to, that deposited hard material.

The base substrate comprises a material body having a suitable shape, configuration and size to deposit the tool material to form the desired cutting formation configurations. The base substrate can also be formed from any suitable material. In embodiments, the base material is formed from a metal or a metal alloy for example an iron or iron alloy such as a steel. In embodiments, the base substrate comprises a blank, rod, or shaft. In embodiments, the base substrate comprises an elongate body, such as an elongate blank, rod or shaft. In some embodiments, the base substrate comprises a metal rod or blank, such as a steel rod, or a 4140 grade steel rod. In this respect, the base substrate can be formed of a lower cost material (compared to the cutting formations) in the form of a cylindrical blank which is cut to size from rods purchased off-the-shelf. The use of ready-made standard material as the base substrate for creating cutting tools helps lower the production cost by only adding the more expensive hard material at the cutting edges as a net shape before the cutting edges are ground to an edge. In some embodiments, the base substrate comprises a cylindrical rod having a diameter of 10 to 250 mm, preferably 10 to 50 mm, more preferably 10 to 20 mm, and, preferably having a length of 50 to 200 mm, more preferably 90 mm. However, the dimensions of the blank (base substrate), the thickness of the inner matrix layer and the hard material layer can vary depending on the type, shape and/or dimensions of the tool to be manufactured. Preferably, the hard material layer has a sufficient thickness such that the cutting edge (the most hard-wearing portion) of the tool It should be appreciated that the base substrate should not be limited to being formed from steel 4140 and could be formed from any suitable material as noted previously. It should also be appreciated that the base substrate does not necessarily have to have a cylindrical configuration, and that other configurations can be used.

The tool material is typically deposited onto the base substrate circumferentially and axially (longitudinally) relative to the longitudinal axis of the base substrate. In some embodiments, the deposited tool material results in a spiral pattern for the deposit body (tracks). In other embodiments, the deposited tool material follows a particular deposition path matching the shape and configuration of the cutting edge of the cutting tool that is being produced. In each case, this requires multi-axis deposition and associated relative movement between the deposition tools (for example the laser beam and powder feed nozzles) and substrate. In embodiments, the additive deposition step includes the step of:
rotating the base substrate about said longitudinal axis to deposit tool material circumferentially on the base substrate relative to the longitudinal axis; and
providing relative movement between a tool material deposition outlet and the base substrate to deposit tool material axially on the base substrate relative to the longitudinal axis.

Uniform microstructures with high level of hardness at the cutting edge can be achieved by designing a suitable toolpath scheme for the tool material deposition. The tool path can have various schemes depending on the desired configuration of the cutting formations. The tool path scheme can determine the heat management strategy, as cooling rates influence microstructures on the solidifying deposits and porosity formation due to gas evolution. In embodiments, the tool material is deposited using a spiral deposition pattern around the base substrate and axially along the base substrate relative to the longitudinal axis. In other embodiments, the tool material is deposited along a tool path defined to deposit in a straight line or curved line that follows geometry of a selected cutting formation along the length of the base substrate. That geometry may comprise a linear flute geometry, helical pattern geometry, or spiral pattern depending on the final geometry of the cutting formation. Of course, it should be appreciated that other geometries are also possible.

The base substrate is preferably preheated to at least 200° C. prior to depositing the tool material thereon using the laser beam of the LMD system (see below). Prior to deposition, the base substrate can be preheated in an oven to an initial temperature to speed up the preheating process. For example, the blank could be heated in an oven or other type of heater to a temperature from 200 to 300° C., for example 200° C. or 250° C. The base substrate can also, preferably in addition to oven heating, be preheated by the deposition heat source, for example a laser beam, prior to the additive deposition step.

Defects can also be reduced and/or substantially eliminated through manipulation (positioning) of the powder injected into the melt pool formed by the heat supplied by the laser beam. In some embodiments, for the additive deposition step, a laser metal deposition (LMD) process is used which includes a laser, and wherein the laser has laser power set at:
between 900 and 500 W for deposition of the matrix material; and
between 600 and 300 W for deposition of the hard material

In some embodiments, for example during spiral deposition forming a cylindrically shaped body, different power strategies are desirable to control heating of the preform during the deposition step. In these embodiments, for the additive deposition step, a laser metal deposition (LMD) process is used which includes a laser, and wherein the laser has power set at:
a 800 to 600 W linear ramp for deposition of the matrix material; and
a 550 to 450 W linear ramp for deposition of the hard material.

In some embodiments, for example where the tool material is deposited along a tool path defined to deposit in a straight line or curved line that follows a linear flute geometry, helical pattern geometry, or spiral pattern geometry of a selected cutting formation along the length of the base substrate, no ramping or power switching/adjustment is required during the deposition step.

In some embodiments, the process includes a preheating step using the laser, beam preferably in a defocused configuration, to preheat the base substrate, in which the laser power is set at: 500 W for said preheat step.

For some embodiments, for example during spiral deposition forming a cylindrically shaped body, the material properties of the next layer to be deposited can be improved by allowing the previously deposited layer to cool, prior to depositing that next layer thereon. The lower temperature of the previously deposited layer encourages faster cooling rates in the next layer which are associated with more desirable (finer) microstructures. In embodiments where the deposit body is formed using at least two layers of tool material, each layer can be deposited with a delay of at least 1 minute, preferably at least 2 minutes, more preferably at least 3 minutes between the deposition of each subsequent deposition layer. In some embodiments, there is a 3 minute delay between layers 1 and 2, and a 2 minute delay between layers 2 and 3. Time delay of up to 5 minutes could be used. It should be appreciated that the ideal delay time is determined by tool geometry, deposit scheme, temperatures, material composition and desired cooling rates associated with optimal deposit microstructures.

In embodiments, the tool material is deposited following a material deposition track having a track width, with each adjoining material deposition track being deposited with an overlap of at least 20%, preferably at least 30% and more preferably at least 50% of the track width. For example, when for example during spiral deposition forming a cylindrically shaped body, at least 40%, preferably at least 50% overlap of the track width is preferred. In some embodiments, each adjoining material deposition track being deposited with an overlap of at least 60%, preferably at least 70% and more preferably around 80% of the track width. For example, for deposition of at least one flute on a spiral or helical path, at least 70%, preferably at least 80% overlap of the track width is preferred.

Defects in the deposited material (including in-situ alloying) can be controlled through atmospheric control and/or manipulation of tool material (typically an alloy powder) fed.

The atmosphere around the deposited material can be controlled using a cover gas, preferably an inert cover gas such as argon. Thus, the deposition step can include the step of: supplying an inert cover gas and/or an inert gas atmosphere over the base substrate during deposition of the tool material. The inert cover gas or atmosphere can be selected from nitrogen or a noble gas, for example neon or argon. In preferred embodiments, the inert gas is argon. The deposition process can be contained within an enclosure to maintain the inert gas atmosphere over substrate as the tool material is deposited. The enclosure can preferably enclose the substrate/workpiece, coaxial and/or side injection nozzles and other instrumentation. The cover gas and enclosure reduces, preferably substantially eliminates, oxygen, moisture and/or nitrogen contamination to the melt pool, thus avoiding the formation of gases (as reaction products) that can be entrapped as pores within the solidifying deposits. Using these techniques, the O₂ concentration around the workpiece during the depositing step is preferably limited to less than 5%, preferably less than 1%, more preferably less than 0.5%. The use of an inert atmosphere provides tangible reductions in porosity. The inert gas atmosphere can be contained in any suitable enclosure, for example a flexible cover, container, cabinet or other purpose built enclosure such as a glove box or the like.

The cutting tool is subjected to a pre-grinding heat treatment process to encourage the reprecipitation of the hard carbide precipitates in the deposited tool material. This aims to produce higher hardness levels in the material of the cutting formations. In embodiments, the process of the present invention further includes the step of: heat treating the base substrate and deposit body formed thereon at a temperature of 500 to 700° C., preferably between 50° and 600° C., more preferably about 550° C. This heat treatment step occurs prior to the subtracting step, i.e. after the additive deposition step. The heat treatment step can be conducted for a suitable time to encourage the reprecipitation of the hard carbide precipitates in the deposited tool material, for example at least 60 minutes, preferably at least 90 minutes,

The final microstructure (and thus properties) of the deposited tool material can be affected by how the material powder is fed onto the base substrate. Where the tool material is deposited onto the base substrate using a LMD process which includes a laser source which directs a laser onto a deposition area of the base substrate to form a melt pool therein and a powder feeding nozzle which directs the tool material into the melt pool, that fed material can be fed directly into the melt pool, or could be fed at a location away from the center of the melt pool. For the inner matrix material, that material is preferably fed onto the deposition surface coaxial to the laser beam and focused into the centre of the melt pool. However, the hard material powder is preferably fed at a location away from the center of the melt pool. In this respect, the melt pool extends in the direction of the path of the laser and trailing behind the laser beam. The hard material powder is preferably fed onto the deposition surface at or proximate the trailing side of the melt pool (the tail end of the melt pool), preferably with a side injection nozzle. In some embodiments, the hard material powder is fed from in front of the laser beam, to be injected through the laser beam with a powder deposition pattern having a center located at or past the trailing side of the melt pool. It should be appreciated that a side injection nozzle can deposit powders in an elliptical pattern (rather than a circular pattern) as the axes of the single nozzle and laser beam are at an angle. The powder deposition pattern may therefore be substantially elliptical. In embodiments, the powder deposition pattern is substantially elliptical having a center located at or past the trailing side of the melt pool. Here the powder in the tail end of the powder deposition pattern (i.e. the end closest to the laser beam and melt pool) is deposited into the melt pool, with the powder in the leading end of the powder deposition pattern (i.e. the end furtherest from the laser beam and melt pool) does not impinge/deposit into the melt pool.

The subtracting step preferably comprises a subtractive machining process to produce the shape of at least one cutting formation including the lands, sharp cutting edges and/or flutes thereon. The subtracting step cuts, grinds, drills, turns, mills, and/or shapes the cutting formations into the final shape and configuration of the cutting tool. The subtracting step comprises a subtractive machining step in which selected portions of the deposit body are removed to produce a selected cutting edge configuration in each of the at least one cutting formations. Subtractive manufacturing or machining involves cutting, hollowing, or taking parts out of a substrate or workpiece.

The subtractive step can be performed by any suitable machining operations including, but not limited to, one or more of grinding, turning, drilling, milling, shaping, planing, boring, broaching or sawing. In embodiments, the subtracting step comprises at least one of a: cutting, grinding, drilling, turning or milling process, preferably a grinding process. It should be appreciated that milling, turning or drilling of hard materials, such as the tool material of the present invention, can be difficult and typically requires special cutting tools. In embodiments, the subtractive step is preferably performed by grinding. Grinding can be performed using an number of grinding arrangements, for example a diamond cutter, or using a cubic boron nitride grinding wheel.

The cutting tool preferably provides a cutting edge with a higher hardness than the commercially available high speed steel cutter HSS M2—while still maintaining excellent toughness. This provides a tool that will last longer than standard HSS and which can also be used in high hardness materials—closing the gap between the higher cutting speeds of carbide tooling. In some embodiments, the cutting edge of the cutting tool has a hardness (Vickers hardness) of at least 1000 HV_{0.5}, preferably at least 1100 HV_{0.5}, and more preferably at least 1200 HV_{0.5}. In some embodiments, the cutting edge of the cutting tool produced from the method has a hardness of at least 1300 HV_{0.5}. In some embodiments, the cutting edge of the cutting tool produced from the method has a hardness of at least 1400 HV_{0.5}. In some embodiments, the cutting edge of the cutting tool produced from the method has a hardness of at least 1500 HV_{0.5}. The cutting tool is preferably substantially defect free having substantially no cracking defects and substantially no porosity defects.

It should be appreciated that hardness in this specification is referred to in terms of the materials Vickers Hardness HV_{0.5} as measured using a Vickers hardness test. A Vickers hardness test uses a diamond shaped indenter (or square-based pyramid) to provide a hardness number which is determined by the load over the surface area of the indentation.

The method can comprise a two-step manufacturing process, where the steps are conducted in separate additive and subtractive manufacturing processes, or in a continuous process in which the steps are conducted sequentially in a single process and/or machine. In some embodiments, the two-step process can be handled as a high-productivity automated sequence in a hybrid additive/subtractive (HAS) machine or in a HAS machining cell that comprises additive manufacturing (AM) and subtractive manufacturing (SM) machines.

The LMD/DED process is a rapid technique for deposition when compared with powder bed 3D printing, which is another way of additive manufacturing. Conventional machining/grinding processes of the base substrate, where significant volume of materials is removed, is also slow. A high-productivity automated sequence in a hybrid additive/subtractive (HAS) machine provides options for changes in cutting edge/cutting formation design and in deposition of cutting edges on demand and, since the volume to be built and then machined out is relatively small, the turnaround time is substantially less. This is further amplified for bespoke designs which are not supported by traditional manufacturing methods. Furthermore, the HAS production process can be fully customised. All process and input parameters can be incorporated in a single unit with simple turn-key options for the operator to run production cycles.

A HAS machine (or machining cell) also offers greater flexibility in the design and testing new geometries of cutting edges. Design software generates new geometries which are then fed into the HAS machine to produce new tools and finally ground in the same machine to produce cutting tools as per the designed specifications. This flexibility cannot be obtained in the conventional process at low cost.

The cutting tool produced by the process of the present invention can have any suitable configuration. In embodiments, the cutting tool is a machining tool comprising at least one of a cutter, milling cutter, power skiving cutter, annular cutter, drill, reamer, tap, insert, blade, broach, shaper or gear hob.

A second aspect of the present invention provides a cutting tool formed using the process according to the first aspect of the present invention.

A third aspect of the present invention provides a cutting tool comprising:
a base substrate having a longitudinal axis,
at least one cutting formation extending from the base substrate having a selected cutting edge configuration,
wherein each cutting formation comprises a matrix compound forming the desired shape and configuration of the cutting formation and a hard compound located over the matrix compound forming the outer surface layer of each cutting edge,
and wherein the hard compound comprises a mixture of the matrix compound and a hard material, the hard material comprising at least one of WC, TaNbC, or a metal matrix composite comprising at least one of WC or TaNbC, in combination with at least one of Co or Ni.

The cutting tool of the third aspect of the present invention is preferably formed from the process of forming a cutting tool of the first aspect of the present invention. As explained for the first aspect of the present invention, each cutting formation is formed from a deposit body which is deposited onto the base substrate using an additive deposition process, preferably selected from at least one of: laser metal deposition (LMD) process, direct metal deposition (DMD), or other types of DED processes. In the additive deposition process, each deposited layer is formed through a melted/molten mixture of the material of the underlying melted layer and the deposited material. Thus, the material composition of each cutting formation of this third aspect of the present invention comprises a mixture of materials formed from this melted/molten mixture, termed here the “matrix compound” and the “hard compound”.

It should therefore be understood that the “matrix compound” comprises a mixture of the inner matrix material (deposited material) and the material of the base substrate, and that the “hard compound” comprises a mixture of the matrix compound and the hard material. Here, the matrix compound includes the inner matrix material mixed with the material of the underlying layer onto which that inner matrix material has been deposited. The matrix compound therefore typically comprises a mixture of material of the base substrate (base substrate material) and the inner matrix material. Here the matrix compound is formed through a melt mixture of the additively deposited inner matrix material and base substrate for the first deposition layer, or in subsequent deposition layers of the inner matrix material, the additively deposited inner matrix material and the matrix compound from the underlying layer. Similarly, the hard compound is formed through a melt mixture of the additively deposited hard material and the underlying matrix compound.

It should be appreciated that the term “compound” in “matrix compound” and “hard compound” means that this composition is a compound composition composed of two or more separate materials that have been combined together to form the mixed composition. This should not be confused with a chemical compound which requires chemical bonding between at least two different elements to form a molecule.

The hard composite forms the outer deposited layer of the cutting formation, and includes the hard material required for the cutting edge of the cutting formation. The hard composite comprises a mixture of the matrix compound and the hard material. In embodiments, the hard material comprises a WC, TaNbC or a WC or TaNbC containing alloy or composite composition. That hard material can comprise at least one of: WC, TaNbC, or a metal matrix composite comprising at least one of WC or TaNbC with at least one of Co or Ni. It should be appreciated that the Co or Ni functions as a binder material (the matrix) in that metal matrix composite. In embodiments, the hard material comprises at least one of WC, WC-6Co, WC-12Co, WC-6Ni or TaNbC.

The matrix compound includes the inner matrix material mixed with the material of the underlying layer onto which that inner matrix material has been deposited (i.e. either the material of the base substrate or the matrix compound of the preceding deposited layer of inner matrix material formed into). The inner matrix material preferably comprises a martensitic iron alloy with molybdenum boride and vanadium carbide; or a metal matrix composite comprising WC with at least one of Ni, Cr, Si or B. In embodiments, that metal matrix composite comprises WC in a NiCrSiB or NiSiB matrix. In preferred embodiments, the inner matrix material comprises a martensitic iron alloy with molybdenum boride and vanadium carbide; and the hard material comprises WC-12Co.

The base substrate comprises a material body having a suitable shape, configuration and size to deposit the tool material to form the desired cutting formation configurations. The base substrate can also be formed from any suitable material. In embodiments, the base material is formed from a metal or a metal alloy for example an iron or iron alloy such as a steel. In embodiments, the base substrate comprises a blank, rod, or shaft. In embodiments, the base substrate comprises an elongate body, such as an elongate blank, rod or shaft. In some embodiments, the base substrate comprises a metal rod or blank, such as a steel blank, or a 4140 grade steel blank. In embodiments, the base substrate comprises a cylindrical rod having a diameter of 10 to 250 mm, preferably 10 to 50 mm, more preferably 10 to 20 mm, and, preferably having a length of 50 to 200 mm, more preferably 90 mm. It should again be appreciated that the base substrate should not be limited to being formed from steel 4140, and could be formed from any suitable material as noted previously. Again, it should be appreciated that the base substrate does not necessarily have to have a cylindrical configuration, and that other configurations can be used.

The cutting tool preferably provides a cutting edge with a higher hardness than HSS M2—while still maintaining excellent toughness. This provides a tool that will last longer than standard HSS and which can also be used in high hardness materials—closing the gap between the higher cutting speeds of Carbide tooling. In some embodiments, the cutting edge of the cutting tool has a hardness (Vickers hardness) of at least 1000 HV_{0.5}, preferably at least 1100 HV_{0.5}, and more preferably at least 1200 HV_{0.5}. In some embodiments, the cutting edge of the cutting tool produced from the method has a hardness of at least 1300 HV_{0.5}. In some embodiments, the cutting edge of the cutting tool produced from the method has a hardness of at least 1400 HV_{0.5}. In some embodiments, the cutting edge of the cutting tool produced from the method has a hardness of at least 1500 HV_{0.5}. The cutting tool is preferably substantially defect free having substantially no cracking defects and substantially no porosity defects.

A fourth aspect of the present invention provides a process of repairing or resharpening a cutting tool that comprises at least one cutting formation having a cutting edge formed on a base substrate having a longitudinal axis, the process comprising the steps of:
additive deposition of at least one layer of a tool material comprising at least one of: tungsten carbide, TaNbC, a tungsten carbide containing alloy or composite, or a TaNbC containing alloy or composite onto at least one cutting edge of the at least one cutting formation to form a repair deposit; and
subsequently subtracting selected portions of the repair deposit body to repair or resharpen the at least one cutting formation.

The fourth aspect provides a process to repair, rebuilt and/or resharpen a cutting tool. This fourth aspect uses the process of the first aspect of the present invention to repair, rebuilt and/or resharpen an existing cutting tool, for example a cutting tool where the cutting edge is worn or damaged. That cutting tool may have been formed using the process of the first aspect of the present invention, or may be formed using a different process.

It should be appreciated that cutting tools made using the technology can be rebuilt, and thus will be the products of choice in many sectors including environmentally conscious businesses. Many of the large style cutting tools would have significant value invested in them, so rather than these items being stripped and sent back through the manual process it could be placed back directly into the additive machine, digitised and rebuilt to the original specification. Thus, when cutting edges of a tool get blunt, it requires regrinding to recreate sharp edges, and this regrinding process makes the tool undersize. After multiple instances of regrinding, the undersize tools are no longer acceptable, and they are required to be replaced. Such tool changing not only affects the production rate of components, but also requires collection and recycling of undersized tools—both adding to the production costs. There is also the issue of cutting edge damage (chipping) where the tool must be scrapped. The tool manufactured by the current invention can deliver longer machining operation due to higher hardness of the additively built cutting edges (compared with HSS tool) and most importantly, if the cutting edges get blunt or damaged, these edges require a small build which can be rebuilt relatively quickly. This rebuilding option can reduce material wastage and the need for expensive recycling. Depending on tool type, a tool could be rebuilt 10 to 20 times for the cost of a new tool.

As with the first aspect, the additive deposition process preferably comprises at least one of: a laser metal deposition (LMD) process or a directed energy deposition (DED) process.

The cutting tool being repaired, rebuilt or resharpened is preferably a machining tool comprising at least one of a cutter, milling cutter, power skiving cutter, annular cutter, drill, reamer, tap, insert, blade, broach, shaper or gear hob. The cutting formation of such a cutting tool can include at least one land, flute, blade, protrusion, ledge, ramp, depression, or channel.

The repair, rebuild or reshaping process preferably deposits a hard material over the cutting edge. The tool material therefore preferably comprises a hard material comprising at least one of WC, TaNbC, or a metal matrix composite comprising at least of WC or TaNbC, in combination with at least one of Co or Ni. It should be appreciated that the Co or Ni functions as a binder material (the matrix) in that metal matrix composite. In embodiments, the hard material comprises at least one of WC, WC-6Co, WC-12Co, WC-6Ni or TaNbC.

The movement and depositing process of the additive deposition step can have various factors. In some embodiments, the additive deposition step includes the step of: rotating the base substrate about said longitudinal axis to deposit tool material circumferentially on the base substrate relative to the longitudinal axis; and providing relative movement between a tool material deposition outlet and the base substrate to deposit tool material axially on the base substrate relative to the longitudinal axis. In some embodiments, the deposit body is formed using at least two layers of tool material and wherein each layer is deposited with a delay of at least 1 minute, preferably at least 2 minutes, more preferably at least 3 minutes between the deposition of each subsequent deposition layer.

Heat treatment can assist in optimising the properties of the deposit body. The process may therefore further include the step of: heat treating the base substrate and deposit body formed thereon at a temperature of 500 to 700° C., preferably between 500 and 600° C., more preferably about 550° C. This heat treatment step occurs prior to the subtracting step, i.e. after the additive deposition step.

The deposition step preferably includes supplying an inert cover gas and/or an inert gas atmosphere over the base substrate during deposition of the tool material. The inert gas is used to limit the O₂ concentration, moisture and/or nitrogen around the workpiece during deposition of the tool material. It should be appreciated that moisture can dissociate to O₂ in this process and should therefore also be limited. The O₂ concentration around the workpiece during the depositing step is preferably limited to less than 5%, preferably less than 1%, more preferably less than 0.5%.

The tool material feeding characteristics can also be varied to optimise material properties. In some embodiments, the tool material is deposited onto the base substrate using a LMD process which includes a laser source which directs a laser beam onto a deposition area of the base substrate to form a melt pool therein and a powder feeding nozzle which directs the tool material into the melt pool, wherein the hard material powder fed onto the deposition surface at or proximate the trailing side of the melt pool (the tail end of the melt pool), preferably with a side injection nozzle. The hard material composition powder is preferably fed from in front of the laser beam, to be injected through the laser beam with a powder deposition pattern having a center located at or past the trailing side of the melt pool.

The subtracting step is used to reshape the cutting edge to its previous desired configuration. As explained in relation to the first aspect, that subtracting step preferably comprises a subtractive machining process comprising at least one of a: cutting, grinding, drilling, turning or milling process, preferably a grinding process.

A fifth aspect of the present invention provides a repaired or resharpened cutting tool formed using the process according to the fourth aspect of the present invention.

The present invention provides the following advantageous outcomes:
An automated process to replace the manual steps of brazing carbide inserts onto the body of a tool blank.
Eliminating manual steps so as to significantly reduce the lead time taken to produce the part, producing higher production rates when both aspects of additive and subtractive processes are integrated. In addition, as the automated process is highly repeatable, the controlled deposition can be tuned to produce minimal defects. The higher productivity combined with lower reject rates further contributes to lowering the production costs.
Less material usage and wastage, since the bulk of the tool body is preferably sourced from off the shelf structural steel rod or form upon which cutting edges are additively built to near net shape. In comparison, conventional tool making process requires a significant percentage of material reduction by machining or grinding from the steel alloy blank, to create the geometries of the cutting edges on the blank itself.
Lower material costs—The materials forming the harder edges are much more expensive than the steel material that the blank is made of. Thus, the sparing use of the more expensive material in the invention contrasts with the traditional tools where the entire tool body is made of an expensive hard material.
Critical Resource Materials—Both Tungsten and Cobalt are list on the European list of critical materials, this process significantly reduces the use of these materials.
The ability to create complex cutting edge profiles with unique geometry. Design of custom complex tool geometry is now made possible, carbide tipped tools limit the ability to place the cutting edge. The additive process now allows the tool designer to place and build the cutting edge to any shape and size.
The ability to rebuilt a cutting tool formed using the process of the present invention to its original form using the process therefore reducing waste.

It should be appreciated that the cutting tool of the present invention can be used for machining a variety of materials, including metal, plastic, timber and nylon. Other applicable materials include rocks, dental materials, carbon fibres, and metal matric composites. The cutting tool of the present invention can also be utilised as alternate tool and equipment where hard surfaces are necessary and/or beneficial for improved wear performances, for example, hardfacing tools and surfaces in mining and resources, agriculture, wood processing, pulp and paper, general engineering, cement, steel and aluminium, printing, bulk and materials handling, quarries, and oil and gas.

The cutting tool of the present invention can comprise at least one of a cutter, milling cutter, power skiving cutter, annular cutter or drill. In embodiments, the cutting tool is a machining tool comprising at least one of a cutter, milling cutter, power skiving cutter, annular cutter, drill, reamer, tap, insert, blade, broach, shaper or gear hob. The cutting or cutter tool types can include, but are not limited to, taps, reamers, countersinks, router bits, drill bit or the like. The cutting tool of the present invention can be used in a variety of cutting applications. Applications include (but are not limited to):
The metal machining field such as a wide range of structural and alloyed steels, aluminium and its alloys, copper and its alloys.
Timber shaping field such as wood chipping, mulching, carpentry, or the like.
Plastic, timber, nylon, and similar materials.

### BRIEF DESCRIPTION OF THE DRAWINGS

The present invention will now be described with reference to the figures of the accompanying drawings, which illustrate particular preferred embodiments of the present invention, wherein:

FIG. 1 provides a schematic of the experimental blown powder, laser metal deposition equipment for depositing tool material on a base substrate, showing (A) a 6-axis Yaskawa Motoman robot, workpiece, powder hopper; and (B) a 4 kW Laserline laser source.

FIG. 2 illustrates a cylindrical blank, a 4140 steel base substrate (blank), mounted in a rotary chuck prepared for additive deposition using the method according to one embodiment of the present invention.

FIG. 3 provides a schematic of the central powder feeding nozzle and laser optic head of the laser metal deposition equipment shown in FIG. 1.

FIG. 4 provides a schematic of two different metal deposition schemes, showing (A & B) deposition of the inner matrix material (for example Metco 1030A powder); and (C & D) deposition of the outer hard material (for example WOKA 3111 FC Powder).

FIG. 5 illustrates the inert gas enclosure used to create an inert gas atmosphere around the workpiece using the method according to one embodiment of the present invention.

FIG. 6 illustrates three different powder injection schemes for depositing the tool material onto the base substrate, showing (A) melt-pool leading edge powder feeding scheme; (B) melt-pool trailing edge powder feeding scheme; and (C) melt-pool wake powder feeding scheme. Each of the above feeding strategies use a 1-nozzle side delivery scheme.

FIG. 7 illustrates a spiral deposition pattern/tool path showing (A) the deposit as formed on the base substrate; (B) the location of exposing banded regions of heat affected zones of the deposit; and (C) the final tool configuration after subtractive machining.

FIG. 8 illustrates a longitudinal flute deposition pattern/tool path showing (A) the deposit as formed on the base substrate; (B) the location of exposing banded regions of heat affected zones of the deposit; and (C) the final tool configuration after subtractive machining.

FIG. 9A illustrates a spiral deposition pattern/tool that was been produced using a delay of 3 minutes between deposition of each deposition layer.

FIG. 9B illustrates a cross-section of a spiral deposition pattern/tool having a consistent hardness of above 1000 HV_{0.5}, showing (A) Final pass having an average hardness of 1067 HV_{0.5}; and (B) First pass having an average hardness of 809 HV_{0.5.}

FIG. 9C provides a plot showing the hardness achieved on the Metco 1030A deposits after heat treating for 90 minutes at various temperatures.

FIG. 10 provides images of three prototype cutting tools made under a closely controlled Ar atmosphere and ground to shape showing significantly reduced porosity, showing (A) as deposited configuration; (B) Trial 228 cutting tool; (C) Trial 230 cutting tool; and (D) Trial 231 cutting tool.

FIG. 11 provides images of three prototype cutting tools made under a closely controlled Ar atmosphere and ground to shape showing a significant amount of porosity, showing (A) Trial 174 cutting tool; (B) Trial 175 cutting tool; (C) Trial 177 cutting tool.

FIG. 12 provides a cross-section of the cutting tool formed in Trial 212 comprising deposition of two layers of Metco 1030A followed by deposition of one layer of WOKA 3111 FC—where hardness values of close to 1100 HV_{0.5} were obtained.

FIG. 13 provides a cross-section of the cutting tool formed in Trial 232 comprising deposition of two layers of Metco 1030A followed by deposition of one layer of WOKA 3111 FC—where hardness values of close to 1200 HV_{0.5} were obtained.

FIG. 14 provides SEM images of a cross-section of the cutting tool formed in Trial 232, showing (A) a SEM image taken at the center of the cutting tool; (B) an enlarged SEM image of (A) illustrating the WC agglomerates intermixed within the deposited matrix material; and (C) a SEM image of the end of the cutting tool.

FIG. 15A provides SEM images of a cross-section of the cutting tool formed in Trial 232 showing (A) Final pass of Trial 232 5000×; (B) Vanadium X-ray mapping of A; (C) Mo X-ray mapping of A; (D) Final pass of Trial 232 5000×; (E) Fe X-ray mapping of D; (F) W X-ray mapping of D.

FIG. 15B provides Xray mapping images of a cross-section of the cutting tool formed in Trial 232 showing (A) vanadium in an area in the first pass, particles are fine; (B) vanadium in an area in the second pass, particles are fine; and (C) Vanadium in an area of the third pass, particles are dendritic.

FIG. 16A illustrates the shape and configuration of the prototype cutting tool produced by the machining steps showing (A) a perspective view; (B) a front view; (C) an end view; and (D) a cross-section at section A-A of FIG. 16(B), of the cutting tool.

FIG. 16B illustrates an annular cutting tool that could be produced by embodiments of the process of the present invention.

FIG. 17 provides the wear test results obtained from this test for prototypes 197, 228 and 230 along with the traditional tools made of HSS M2 and Carbide GU20F.

FIG. 18 provides optical microscopy images of the surface of the cutting edges after machining trials (almost 39 minutes of cutting).

FIG. 19 provides wear trial results for cutting tools formed from a Metco 1030A/WOKA 3111 FC tool material composition plotting outer corner wear performance as a function of effective cutting time comparing Metco 1030A as built; Trial 212 (Metco 1030A and WOKA3111 FC HT (Heat treated)); Trial 228; and M2 HSS.

FIG. 20 provides a photograph of a large-pitch helical flute-style shape of the additive manufactured (AM) deposit geometries used in this experimental run resembling the cutting edges on tools shown in FIG. 21. The substrate was an off-the-shelf cylindrical 4140 steel shank as shown in FIG. 2.

FIG. 21 provides a schematic of an end mill cutting tool with cutting edges, showing (A) side view; and (B) end view showing the cutting head of the cutting tool.

FIG. 22 provides a photograph of the inert gas enclosure housing the additive deposition equipment, including rotary chuck, powder feeder and laser system as described and illustrated in relation to FIGS. 1A to 5.

FIG. 23 provides an image showing the AM process used for depositing large-pitch helical layers with modified tool paths.

FIG. 24 illustrates the final cutting tool dimensions for the helical flute style deposit experimental runs.

FIG. 25 provides a cross-sectional schematic showing one example of the deposit layers of one deposition flute on a cylindrical 4140 steel shank of the helical cutting tool.

FIG. 26 provides optical images of cross-sections from (A) Trial 290—1 layer/2 tracks and (B) Trial 291—2 layers/2 tracks, showing the differences in profiles from a single layer and a double layer of Metco 1030A.

FIG. 27 provides the results from subtractive test 1, as described in Table 8.

FIG. 28 provides the results from subtractive test 2, as described in Table 8.

FIG. 29 provides the results from subtractive test 3, as described in Table 8.

FIG. 30 provides backscattered images of cross-sections of helical flute deposits as deposited for (A) Trial 423, and (B) Trial 442.

FIG. 31 provides backscattered images of deposits on (A) trial 423 and (B) trial 425.

FIG. 32 provides a backscattered electron image of the concentrated region from trial 425 showing the region (H3). Region H3 was located in the concentrated region of the AM deposit. The WC agglomerate has dispersed in this region.

FIG. 33 provides a backscattered electron image of the transition region from trial 425 showing the region (H9). Region H9 was located within the transition zone of the AM deposit. The Bright white WC agglomerate is intact in this image.

FIG. 34 shows (a) a cross-section of the cutting tool with profile of cutting edges after machining, and (b) the approximate profile superimposed on the deposit.

### DETAILED DESCRIPTION

The present invention provides a method that combines an additive process with a subtractive machining process to form a cutting tool.

Additive manufacturing (AM) is the process of building up 3D components by depositing material one layer at a time. This enables production of parts containing internal cavities, overhangs and lattice structures, all of which would be difficult or impossible to produce using conventional subtractive manufacturing. The ability to produce these geometries enables production of highly optimised parts compared to what was previously possible. AM, also referred to as 3D printing, enables the redesign of complex multi-part assemblies, reducing the number of individual components and leading to lower production and assembly costs.

Subtractive manufacturing or machining involves cutting, hollowing, or taking parts out of a substrate or workpiece. Subtractive machining can be performed by any suitable machining operations including, but not limited to, one or more of grinding, turning, drilling, milling, shaping, planing, boring, broaching or sawing. The subtractive manufacturing step can be automated.

The present invention provides a process of forming a cutting tool that combines an additive process with a subtractive machining process. More specifically, the process generally comprises:
(A) additively depositing a material with a high hardness that would form the cutting edge using a blown powder additive manufacturing system onto a metal blank, such as a steel blank to form a deposit body thereon; and
(B) subsequently subtractively machining, for example grinding, the deposit body to produce the final shape and configuration of the cutting edge and/or flutes of the cutting tool.

The dimensions of the tools produced using the process can be tailored to any desired cutting tool shape and configuration. For example, in some embodiments, the produced cutting tool matches the shape and configuration of standard off-the-shelf wood router tools made by a conventional process of brazing of sintered WC tips on to a steel blank.

### Additive Deposition

The additive deposition step has the following general steps:

The process starts with a base substrate 120—a cylindrical blank of a suitable diameter, for example, but not limited to, 10 to 20 mm, cut to the required length for example, but not limited to, 50 to 200 mm, such as 100 mm. This deposit substrate is a cylindrical blank, typically an off-the shelf structural steel blank of cylindrical shape, of a cost-effective material such as 4140 grade steel tool blank which is cut to size from rods purchased off-the-shelf. One example of a suitable cylindrical blank is a 10 mm diameter 4140 high tensile steel bar sectioned to a length of 90 mm. The use of a ready-made standard material as the substrate for creating cutting tools advantageously helps lower the production cost by only adding the more expensive hardened material at the cutting edges as a net shape before the cutting edges are ground to an edge.

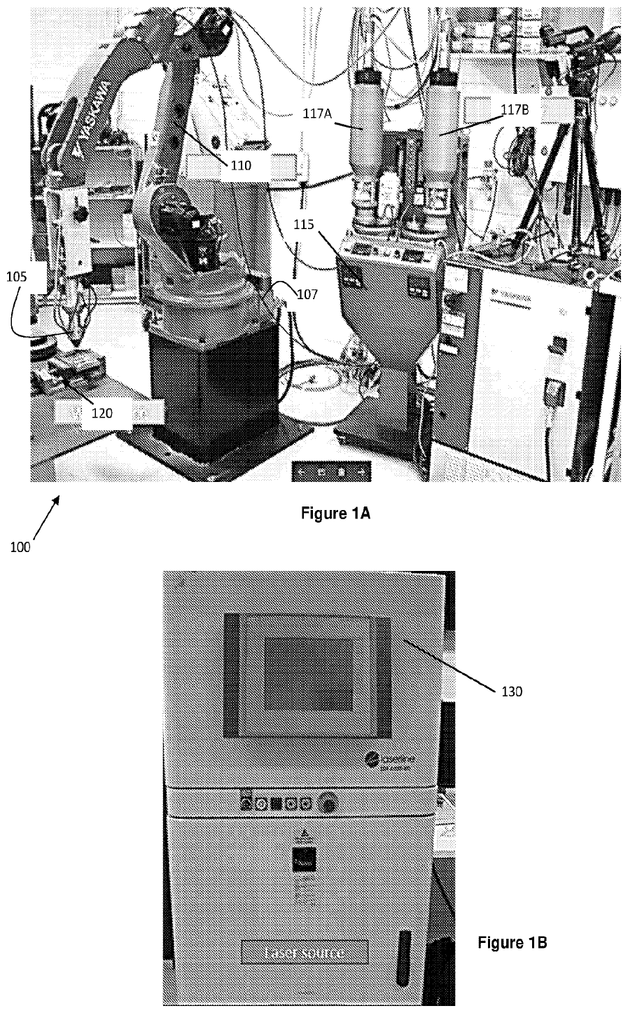

The base substrate 120 undergoes a roughening process, for example grit blasting with aluminium oxide to maximise laser absorptivity and cleaned with acetone. The base substrate 120 is then mounted in a rotary chuck 122 in preparation for laser metal deposition (LMD), as shown in FIG. 1.

The blank/base substrate 120 is preheated to at least 200° C. prior to depositing the tool material thereon using the laser beam of the LMD system (see below). Prior to deposition, the base substrate 120 can be preheated in an oven to an initial temperature to speed up the preheating process. For example, the base substrate 120 could be heated in an oven or other heater to a temperature from 200 to 300° C., for example 200° C. or 250° C. prior to being mounted into the rotating chuck. Preheating is a common procedure used to reduce the internal stresses and chances of cracking due to the thermal shocks associated with heating and cooling cycles.

The tool material is then deposited onto the surface of the base substrate 120 using the equipment set up 100 shown in FIGS. 1A and 1B.

For tool material deposition, the base substrate 120 is rotated in the rotary chuck 122 about its longitudinal axis X-X to enable tool material to be deposited circumferentially on the base substrate 120 relative to the longitudinal axis X-X. The head 105 includes a powder feeder nozzle 131 and laser optics 132 which are mounted on a multi-axis robotic arm 110 providing relative movement between a tool material deposition outlet in head 105 and the base substrate 120 to deposit tool material axially on the base substrate 120 relative to the longitudinal axis X-X. By mounting the head 105 on a robotic arm 110, toolpaths can be generated that follow contours of a surface, even on curved or irregular parts. Powder comprising the tool material is delivered to the powder nozzle of head 105 from powder feeder system 115 which includes powder hoppers 117A and 117B.

The present invention utilises a blown powder additive manufacturing system to deposit a hard material on a lower cost base substrate, such as a steel rod or blank. Examples of suitable blown powder systems include laser metal deposition (LMD) process (also known as direct metal deposition (DMD) or laser cladding), or a directed energy deposition (DED) process as discussed previously. The blown powder additive manufacturing system illustrated in FIGS. 1A, 1B, 3 and 4 includes a laser source 130 (for example, as illustrated, 4 KW fibre delivery diode laser system (Laserline LDF 4.000-60)—FIG. 1B) which is connected to the head of the laser system 105 (FIG. 3) to produce a laser beam 132. It should be appreciated that a variety of other suitable equipment could equally be used for the laser system and other equipment shown in FIG. 1, and that the invention should not be limited to the exemplified equipment and set up.

As best shown in the general schematic illustrated in FIG. 3, blown powder systems typically use a nozzle 131, that typically include a ring of multiple jets (shielding gas 134 and co-axial gas 135) and powder feeder which feeds powder (tool material) 136 through the jets 134, 135, which are located at the end of the head 105. The head 105 moves in deposition direction D (and laser beam movement direction L). A lens (part of the laser head—not illustrated in FIG. 3) is used to focus a heat source, such as high-power laser beam 132 (used in laser metal deposition (LMD) process) onto the base substrate 120 creating a melt pool 138. The powder 136 is blown into the melt pool 138 from the head 105 resulting in material build-up where the fed powder 136 melts and combines with the material of the base substrate 138A (or the previous deposition layer, in the case of subsequent deposition) 120 in the melt pool 138, forming a deposition layer 137, which fuses the materials together when solidified. The deposition layer typically has a layer thickness of 0.2 to 1 mm. The process can be repeated to build a desired shape, in this case a cutting formation, using a sequence of deposition layers built upon each other. A three-dimensional shape can be built up on the base substrate 120 by relatively moving the head 105 (containing the laser 132 and power feed nozzle 131) and the substrate to apply lines, areas, and shapes.

It should be understood that the composition of the deposition layer includes the deposited material and the melted material from the underlying layer, which is melted in the melt pool 138. Here the fed powder 136 melts in the melt pool 138 and combines with the material of the underlying material—namely the base substrate 138 for the first deposition layer, or in the case of subsequent deposition layer—the previous deposition layer. For the first deposition layer, this results in compositional gradient of the deposited material and the base substrate material through the deposition layer 137, with the highest concentration of base substrate material at the bottom of the deposition later 137. For subsequent deposition layers, the material of the underlying deposition layer is combined with that deposition layer in the melt pool 138. In the above, the thickness of the deposition layer refers to the additional thickness of the material that results from the process of depositing the powder material.

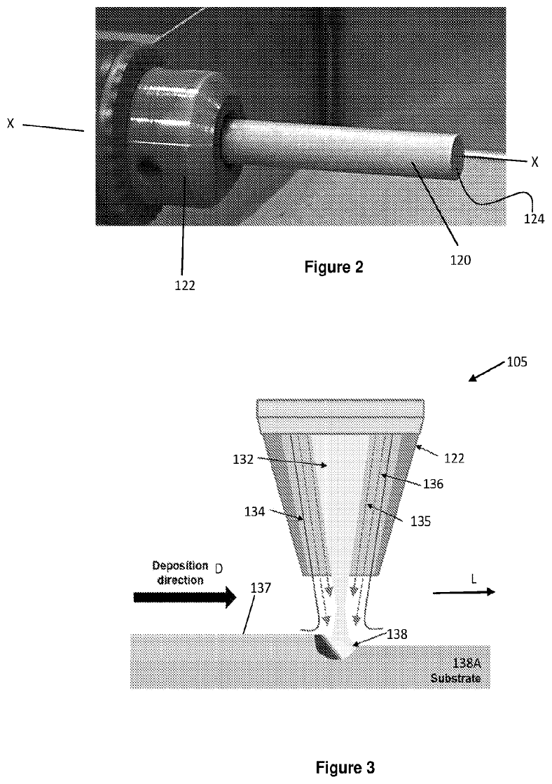

The blown powder process is applied to additively build a hard deposit of a suitable alloy on the surface of a portion of the base substrate 120, typically 20 to 30 mm from one end. In operation, the base substrate 120 in the rotary chuck 122 (FIG. 2) is rotated at a pre-determined rate while the laser beam 132 and the coaxial nozzle 131 are moving linearly to deposit the tool material layers in desired deposition tool path.

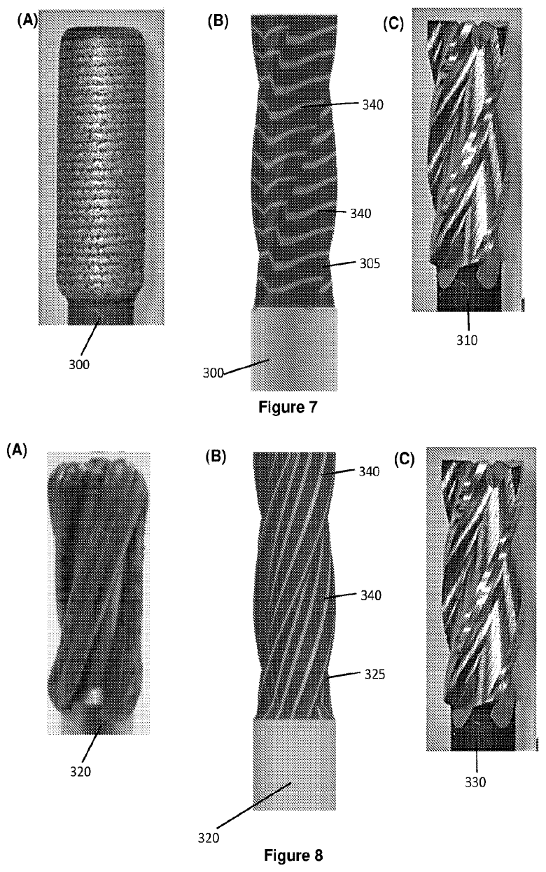

Material deposition follows a programmed pattern to form the desired shape. Two different deposition patterns are illustrated in FIGS. 7 and 8.

FIG. 7 illustrates a spiral deposition pattern where the tool material is deposited along a spiral pattern around the cylindrical blank to form a cylindrical deposit 300 having the circumferentially extending spiral deposits 305 shown in FIG. 7B. The final cutting tool configuration 310 after the subtractive step is shown in FIG. 7C. To form the spiral deposition shown in FIG. 7, tool material deposition is in the form of a spiral over the base substrate 120 and the rotary chuck 122 is set at a suitable rotation speed, for example 31.8 RPM to provide the required tangential speed (laser scan speed) of 1000 mm/min (16.7 mm/s).

FIG. 8 illustrates a longitudinal deposition pattern where the tool material is deposited longitudinally along the flutes forming the cutting formations and cutting edges to form a deposit 320 including axially extending spiral deposits 322 shown in FIG. 8B. This deposit 322 runs over the surface in a straight line, curved line that follows the tool's flute geometry or spirally in a helical pattern along the length. The final cutting tool configuration 330 after the subtractive step is shown in FIG. 8C.

It should be appreciated that the different deposition patterns/deposition paths have various advantages and disadvantages. At the interface between deposition tracks grain growth and other metallurgical changes occur resulting in a weaker and softer microstructure. This weakened region is known as the heat affected zone (HAZ) shown as lines 340 in FIGS. 7 and 8. The spiral deposition pattern shown in FIG. 7 where material is deposited in a revolved fashion along the whole blank results in a near perpendicular intersection between the cutting face and deposition tracks exposing banded regions of HAZ 340 once the cutting formations such as flutes are ground out in the subtractive process post deposition to form the cutting tool 300 shown in FIG. 7C. This can create high wear regions in bands correlating to the HAZ 340 of overlapping tracks. The deposition pattern illustrated in FIG. 8 is to deposit material longitudinally along the flutes with the deposition aligned in such a way as to avoid having any HAZ 340 at the cutting edge. This is thought to result in a far more homogenous and durable cutting edge in the cutting tool 320 shown in FIG. 8C.

The materials to be additively deposited onto the substrate blank typically include an outer (top) surface deposition providing a hard face or surface for the desired cutting edge of the cutting tool configuration. In embodiments, the deposited tool material comprises at least one of WC, TaNbC, or a metal matrix composite comprising at least one of WC or TaNbC, in combination with at least one of Co or Ni. It should be appreciated that the Co or Ni functions as a binder material (the matrix) in that metal matrix composite.

The Inventors have found that the properties of the deposited cutting formation can be improved by building the cutting formation from two different deposition materials (tool materials) comprising an inner matrix material which is deposited onto the blank and a hard (outer) material composition which is deposited on top of the inner matrix material deposits to create a hard in-situ alloyed homogeneous deposit from which the cutting edges can be formed during the subtracting machining process steps. In a cutting tool edge formation, the properties that are desirable include higher hardness, combined with minimal defects such as porosity and cracks. In this two-material composition, the inner matrix material is preferably used usually to bind the hard material composition, and acts as an intermediary material between the hard material composition and the base substrate. The inner matrix material preferably forms the desired shape and configuration of the cutting formation and the hard material composition forms part of the material of the cutting edge thereof. The inner matrix material is preferably selected as a material having a high hardness itself (without the added hard material) and is used for the inner layers deposited onto the base substate. The hard material is deposited onto the inner matrix material as the top deposited layer(s), and through the melt pool (as described above in relation to FIG. 3) intermixes/is dispersed within the inner matrix material of the preceding deposited layer of matrix material. This forms a hard compound comprising a dispersion of the hard material (for example WC agglomerates) within the matrix material (for example Metco 1030A). This hard compound is a composite mixture of hard material dispersed within the matrix material forms the outer section of the deposited body which is used to form the cutting edge.

As illustrated in FIG. 3, each deposited layer is formed through a melted/molten mixture of the material of the underlying melted layer and the deposited material. The material composition of each deposited layer therefore comprises a mixture of materials formed from this melted/molten mixture. Thus, when the inner matrix material is deposited onto the base substrate (the first deposition layer), a matrix compound is formed through a melt mixture of the additively deposited inner matrix material and the material of the base substrate. For subsequent layers of the deposited inner matrix material, a matrix compound is formed through a melt mixture of the additively deposited inner matrix material and the matrix compound from the underlying layer. Similarly, when the hard material is deposited onto the matrix compound (formed from the deposited inner matrix material), a hard compound is formed comprising a mixture of the matrix compound and the deposited hard material.

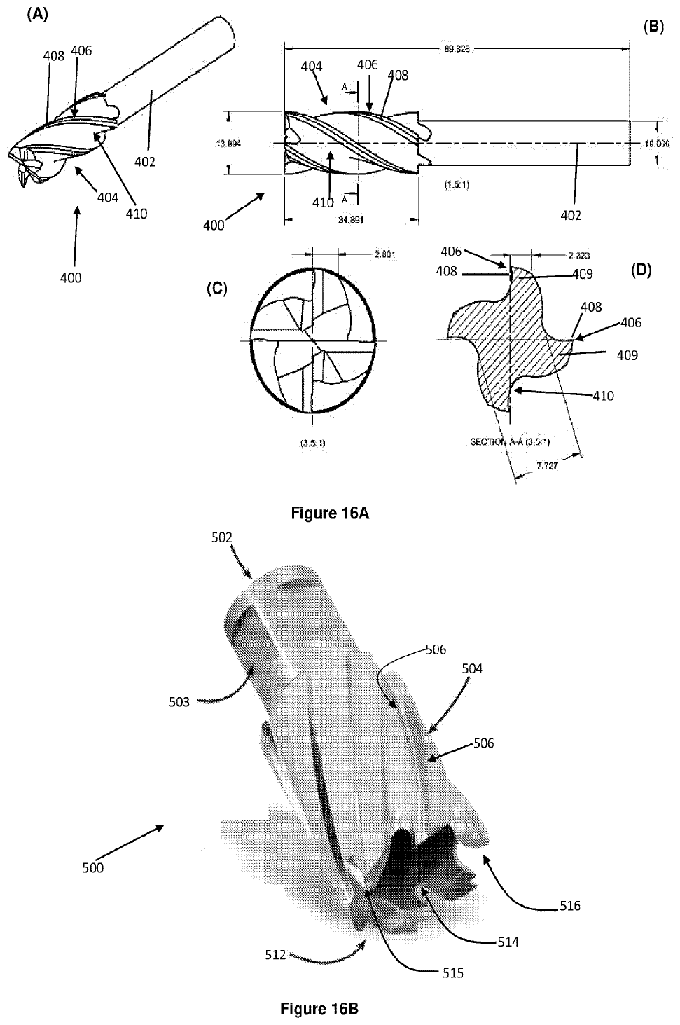

For example, the cutting tool 400 illustrated in FIG. 16A, is formed from a two material composition. The cutting tool 400 comprises a blank 402 as the base substrate onto which the tool material is deposited to form the cutting head 404. The cutting head 404 includes cutting edges 406 formed from the hard compound 408 on the outer edges and have an matrix compound comprising the inner material, which has been deposited onto and has adhered to (fuses with) the blank 402 (base substrate).

As taught earlier in the specification, the inner matrix material typically comprises a martensitic iron alloy with molybdenum boride and vanadium carbide; or a metal matrix composite comprising WC with at least one of Ni, Cr, Si or B. One example is a metal matrix composite of WC in a NiCrSiB or NiSiB matrix. The hard (outer) material typically comprises at least one of WC, TaNbC, or a metal matrix composite comprising WC or TaNbC, in combination with at least one of Co or Ni. Examples include least one of WC, WC-6Co, WC-12Co, WC-6Ni or TaNbC. In preferred embodiments, the inner matrix material comprises a martensitic iron alloy with molybdenum boride and vanadium carbide; and the hard material comprises WC-12Co.

Those material compositions are typically embodied in a commercially sourced materials composition. Examples of materials that have been used by the inventors for the inner matrix material, and hard (outer) material are as follows:
Inner matrix materials: Metco 1030A (53 to 150 μm—a martensitic matrix iron alloy with fine scale, extremely hard molybdenum borides and vanadium carbides with a particle size range of 53 to 150 μm available from Oerlikon Metco (Australia) Pty. Ltd) and Rockit 706 (53 to 180 μm—a martensitic iron based structure with finely dispersed hard vanadium carbides produced by Höganäs AB, Sweden and available from Australian Metal Powder Supplies).
Hard materials: WOKA 50505 (WC-6Co, spherical, 75 to 125 μm—Cemented Tungsten Carbide Pellets available from Oerlikon Metco (Australia) Pty. Ltd), WOKA 50538 (WC-6Ni, 106-180 μm—Cemented Tungsten Carbide Pellets available from Oerlikon Metco (Australia) Pty. Ltd), WOKA 3111 FC (WC-12Co—a thermal spray grade spheroidal powder containing 88% WC as a hard material and a cobalt matrix that functions as a binder material for the WC agglomerated and sintered with a particle size range of 5 to 20 μm—available from Oerlikon Metco (Australia) Pty. Ltd), WOKA 50051 (WC, 20 to 53 μm—Spherical Fused Tungsten Carbides (CTC-S) are spheroidally shaped, two-phase tungsten carbide powders available from Oerlikon Metco (Australia) Pty. Ltd) and ultrafine TaNbC.

In preferred embodiments, the inner matrix material comprises Metco 1030A, and the hard (outer) material comprises WOKA 3111 FC.

The deposit factors depend on the desired properties and composition of the final cutting formation deposited on the blank. As an illustrative example, when using Metco 1030A and WOKA 3111 FC, the two powders are loaded into a Sulzer Metco TWIN 10-C dual hopper powder feeder 115, Metco 1030A in hopper 1 (117A) and WOKA 3111 FC in hopper 2 (117B), as shown in FIG. 1. The feeding rate depends on the tool path and deposition configuration. As an example, hopper 1 (117A—Metco 1030A) can be set to 7.0% RPM which provides a powder flow rate of 20.9 g/min. Hopper 2 (117B—WOKA 3111 FC) can be set to 4.0% RPM which provides a powder flow rate of 10.9 g/min.

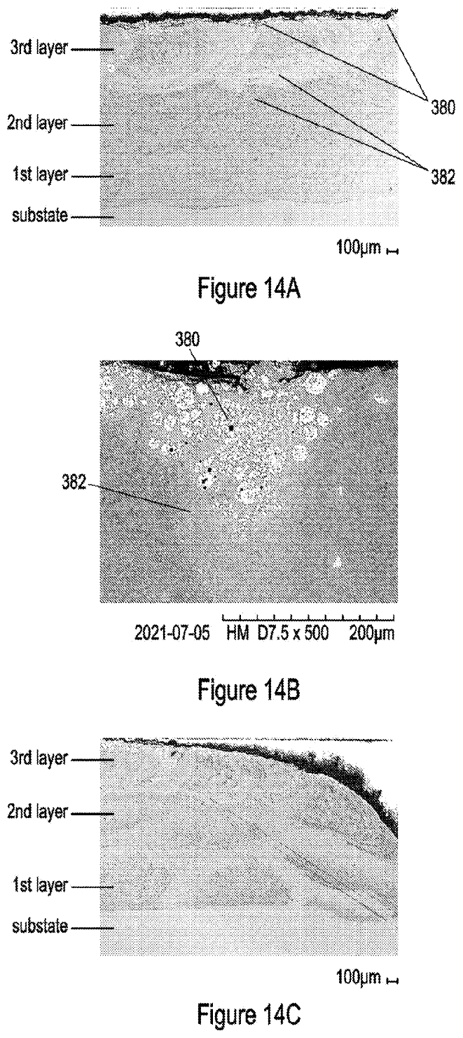

The inner matrix material—Metco 1030A alloyed steel matrix—is deposited first over the base substrate 120 as an underlying (or priming) layers. Subsequently, the hard materials—WOKA 3111 FC (carbides of thermal spray grade 88WC-12Co)—are deposited onto the matrix compound formed from the inner material deposition to form the final layer/s over the matrix materials layers. That material will comprise a hard compound comprising a mixture of the hard material with the matrix compound, for example as illustrated and described below in relation to FIG. 14.

In the illustrated system, the inner matrix material and hard material are deposited by utilising the laser system 130 which is connected to the optical/laser head 105 through optical fibre 107 to create the melt pool 138 (FIG. 3) where the powders are injected into the centre and the tail of the melt pool (FIG. 3). The processing optics consists of a 72 mm collimating lens, a 300 mm focusing lens and a 0.6 mm fibre which produces a 2.5 mm laser beam spot size at the focal point. The powder delivery is by way of a coaxial nozzle for Metco 1030A and a side injection nozzle for WOKA 3111 FC. The coaxial nozzle powder feeder nozzle and laser source (FIGS. 1A, 3 and 4) is mounted on a 6-axis robotic arm 110 (Yaskawa Motoman DX200 MH24) as illustrated in FIG. 1A.

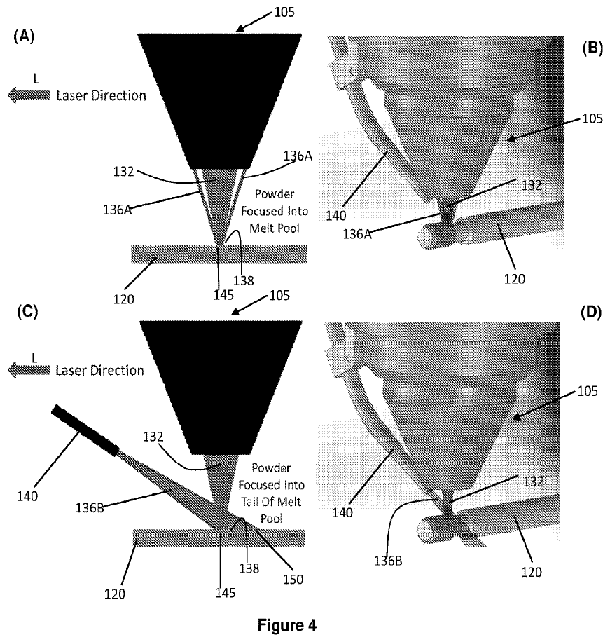

Metco 1030A powder 136A that is injected is coaxially focused into the center 145 of the melt pool 138 (FIGS. 4A and 4B), whilst WOKA 3111 FC is focused into the tail 150 of the melt pool 138 with a side injection nozzle 140 (FIGS. 4C and 4C). The direction of the head movement relative to the base substrate 120 is shown as direction L in FIGS. 4A and 4C.

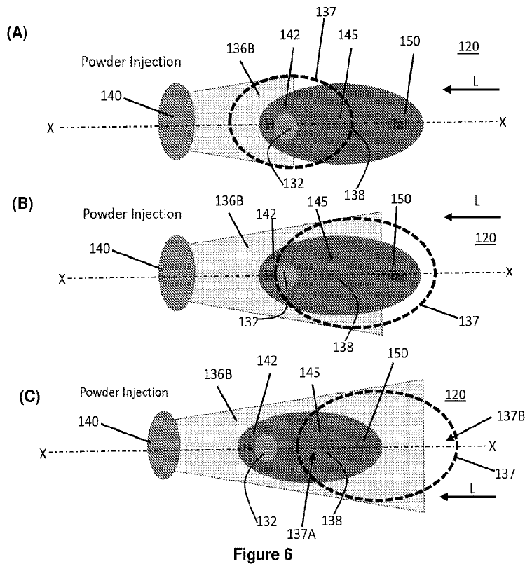

Different possible side feeding patterns is illustrated in FIG. 6. Here three side injection schemes are shown for feeding powder 136B into a melt pool 138. As shown in the FIG. 6, the melt pool 138 extends relative to the longitudinal axis X-X of the base substrate 120 in the direction that the laser beam 132 is moving (direction L), forming a head section 142 of the melt pool 138 at and just ahead of the laser beam 132, a center section 145 of the melt pool 138 and a trailing end or tail 150 of the melt pool 138 trailing behind the laser beam 132. The powder stream from a single side injection nozzle 140 diverges in a conical shape resulting in approximately an elliptical powder impingement pattern on the deposition substrate/surface. This is shown by the powder impingement pattern 137 in FIG. 6, where the powder 136B fed through the single side powder injector nozzle 140 is deposited in an elliptical pattern (rather than a circular pattern) as the axes of the side injection nozzle 140 and laser beam 132 are at an angle.

Whilst not wishing to be limited to any one theory, the Inventors have found that these side-injection schemes appear to influence material properties of the deposited powder. FIG. 6A illustrates a melt-pool leading edge powder feeding scheme—a side powder injection scheme where powder injection is focused into the head section 142 (leading edge) of the melt pool 138, with the powder 136B being injected in front of the laser beam 132. FIG. 6B illustrates a melt-pool trailing edge powder feeding scheme—a side powder injection scheme where powder injection focused into the center 145 and the tail section 150 of the melt pool 138, with the powder 136B being injected from in front of the laser beam 132, so that the powder 136B passes through the laser beam 132 into the melt pool 138. FIG. 6C illustrates a melt-pool wake powder feeding scheme—a side powder injection scheme where powder injection is aimed generally towards the tail section 150 (trailing edge) of the melt pool 138, with the powder 136B being injected from in front of the laser beam 132, so that the powder 136B passes through the laser beam 132. Here the powder deposition pattern 137, which may be elliptical, has a center located at or past the tail section 150 of the melt pool 136. Here the powder in the tail end 137A of the powder deposition pattern (i.e. the end closest to the laser beam 132 and melt pool 136) is deposited into the melt pool 136, with the powder in the leading end 137B of the powder deposition pattern 137 (i.e. the end furtherest from the laser beam 132 and melt pool 136) does not impinge/deposit into the melt pool 136.

In addition to the powder feeding schemes illustrated in FIG. 6, the powder may be delivered using a center powder feed nozzle ‘focused’ scheme whereby the nozzles in head 105 deliver the powder 136A on the substrate surface to coincide with the laser beam axis (since the axes of the laser beam 136 and the nozzles coincide), for example as shown in FIGS. 4(A) and (B). Focused in this respect refers to delivery of powder using multiple coaxial nozzles at distance where streams of all nozzles converge.

Of these three injection schemes shown in FIG. 6, the inventors found that injecting the hard material (for example WOKA 3111 FC powder) from in front of the melt pool into the tail of the melt pool (FIG. 6C) resulted in less defects. Whilst not wishing to be limited to any one theory, the Inventors postulate that for injection of hard material such as WOKA 3111 FC powder:
a. Powder blown through the laser beam experiences pre-heating. Possibly pre-heating of the powder during deposition plays a role in the reduction gas being released in the melt pool.
b. Possibly less WOKA 3111 FC powder is landing in the melt pool overall resulting in a higher matrix to ceramic ratio.
c. Towards the tail of the melt pool temperatures will be lower than those under the laser beam, such that this may avoid a component of the WOKA3111 FC powder decomposing or breaking down compared to when it lands in the higher temperature region at the center or head of the melt pool.

The deposition parameters depend on the material and desired properties. Due to the nature of thermodynamics and materials science, processing parameters including powers and delay times may need to be modified for manufacture of different sized cutting tools.

Examples of deposition parameters to form the spiral deposition cylindrical deposit 300 shown in FIG. 7 is as follows:
1. The robot 110 is programmed to linearly traverse from the tip 124 of the base substrate 120 at 20 mm/s with the laser beam defocused at 100 mm for a preheating process (10 passes) to preheat the base substrate prior to material deposition.
2. The robot 110 is programmed to linearly traverse 35 mm from the tip 124 of the base substrate 120 at 0.64 mm/s laser beam focused for deposition (2 layers of Metco 1030A and 1 layer of WOKA 3111 FC) to provide for a 50% material track deposition overlap (1.2 mm). The laser power is set at 500 W for preheat, 800 to 600 W linear ramp for Metco 1030A deposition and 550 to 450 W linear ramp for WOKA 3111 FC deposition, with the ramp occurring from the start to the end of each deposition layer.
3. There is a 3 minute delay between layers 1 and 2, and a 2 minute delay between layers 2 and 3.

The ramp in power from 800 to 600 W during matrix material deposition along the base substate deposition and from 550 to 450 W during hard material deposition. During deposition, the part heats up resulting in a growing melt pool with higher dilution resulting in sub optimal material properties. Ramping power is a common practice in welding compensate for heat build-up. Whilst not wishing to be limited to any one theory, the Inventors found that ramping downwards of the laser power helped reduce defects in the hard material (WOKA 3111 FC) layer. The ramping down of the power is conducted to reduce heat input which make the deposit unstable in liquid condition and rough when solidified.

Due to the small size of the cylindrical blank/shank, control of heat build-up is a big challenge. Whilst not wishing to be limited to any one theory, the Inventors found that introducing a two-to-three-minute delay after each layer allowed the part to cool to a suitable temperature for the next layer. This is also a common practice in welding and for high power deposition techniques. It should be appreciated that the ideal/optimised delay time is determined by factors including tool geometry, temperatures, material composition and cooling rates as well as he need for the highest possible productivity.

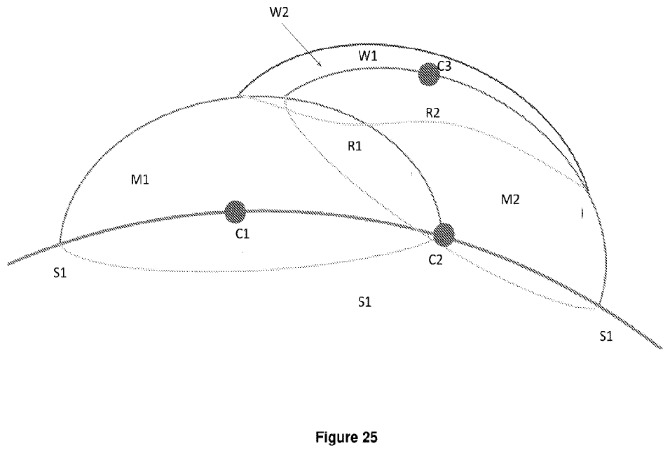

Examples of deposition parameters to form the helical flute deposition deposit 320 shown in FIG. 8 is as follows:
1. The robot 110 is programmed to linearly traverse from the tip 124 of the base substrate 120 at 20 mm/s with the laser beam defocused at 100 mm for a preheating process (20 passes) to preheat the base substrate prior to material deposition.
2. The robot 110 is programmed to linearly traverse 35 mm from the tip 124 of the base substrate 120 at 16.7 mm/s laser beam focused for deposition along a helical path longitudinally down the axial length of the base substrate (1 layer comprising 2 tracks of Metco 1030A and 1 layer of WOKA 3111 FC—see for example FIG. 25 which is described below in Example 2) to provide for a 80% material track deposition overlap (1.92 mm). The laser power is set at 500 W for preheat, 800 W linear ramp for Metco 1030A deposition and 550 W for WOKA 3111 FC deposition, with the ramp occurring from the start to the end of each deposition layer. For helical flute-style deposition pattern (near-net-shape tools) the power ramp-down was not required as the laser was on for a comparatively shorter time compared to spiral deposition.
3. No time delay is required between track deposition for this helical deposition, as heat build-up was found to not be problematic in this build scheme compared to spiral deposition.

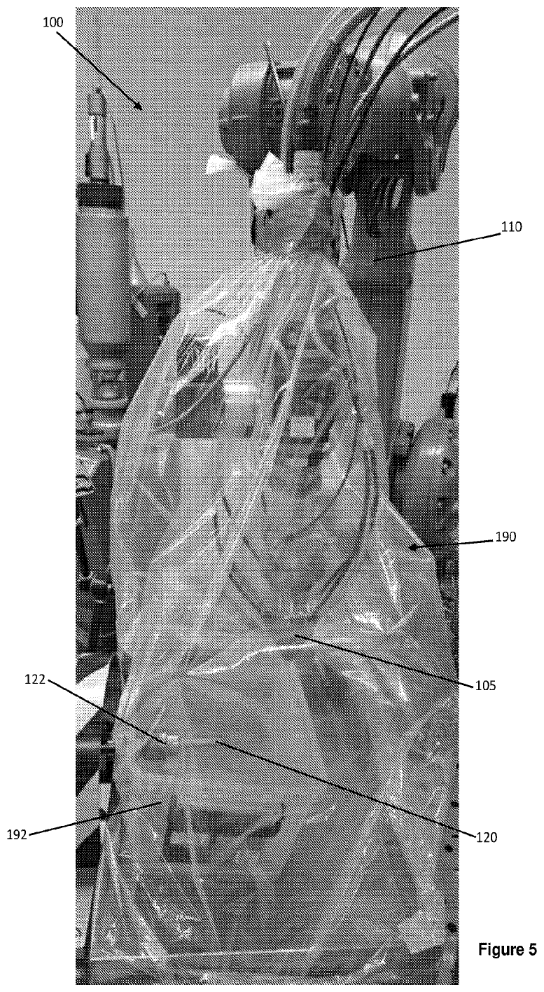

The process is preferably carried out in an argon atmosphere (which contains at most 3% Oxygen, and minimal to no moisture and nitrogen) as shown for example in FIG. 5 with the robot 110, base substrate 120, chuck 122 and head 105 enclosed within a plastic hood 190 to retain the argon atmosphere over the base substrate 120 during material deposition. The base substrate 120 and chuck 122 are contained in a container, in this case a plastic tub 192. Since Ar is heavier than air, the tub contains Ar around the base substrate 120 and also protects the plastic enclosure from being caught in the rotary chuck and rotating base substrate 120 when in operation. An oxygen sensor is located in the tub 192. This enables the atmosphere to be controlled around the base substrate 120 and deposited material as the preform tool piece is formed through the use of argon gas which is contained in a physical enclosure along with the workpiece, coaxial and/or side injection nozzles and other instrumentation. This substantially avoids/cuts off oxygen, moisture and/or nitrogen contamination to the melt pool 138, thus avoiding the formation of gases (as reaction products) that can be entrapped as pores within the solidifying deposits. It should be appreciated that any gas tight housing or enclosure could equally be used in place of the illustrated plastic enclosure. For example, FIG. 22 described for Example 2 provides another example of an argon atmosphere enclosure formed from a modified sandblaster (or glovebox) cabinet.

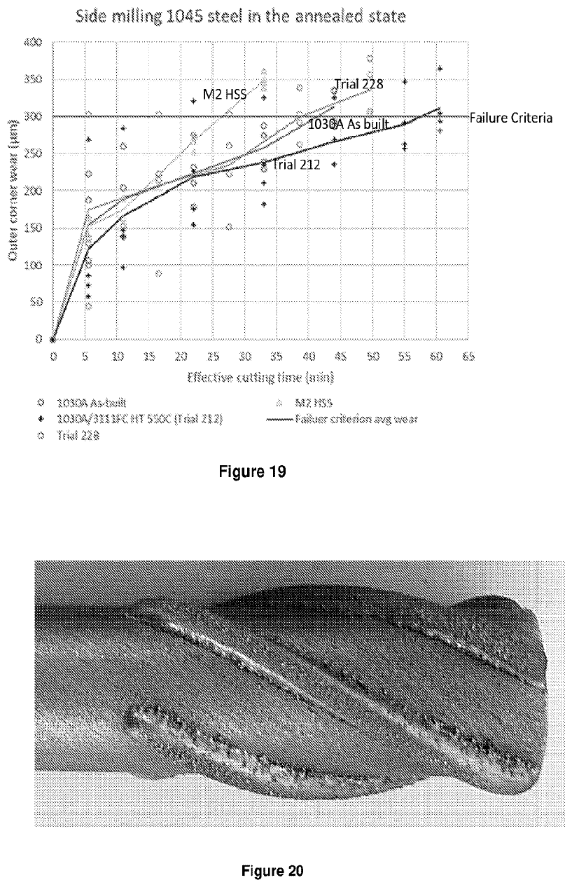

Once the additively manufacture preform is produced, that preform is heat treated to improve the material properties of the deposited material. Heat treatment can be between 40° and 750° C. The Inventors found from sample heat treated in an oven for 450, 550, 650 and 750° C. that the best hardness measurements were obtained on those treated at 550° C. (see FIG. 19 and the examples below). Whilst not wishing to be limited by any one theory, the Inventors believed that this result was due to 550° C. heat treatment temperature allowing some harder precipitates to form. However, at higher temperatures, these precipitates coarsened, reducing hardness.

The resulting laser deposited builds prior to subtractive grinding is shown in FIGS. 7A and 8A.

### Subtractive Machining

The cutting edges are created by using a subtractive machining process: such as grinding. The subtracting steps may include; fluting, outer-diameter finishing, end-face gashing and lastly end-face finishing. The subtracting steps shapes the cutting formations into the final shape and configuration of the cutting tool.

The subtractive machining step has the following general steps:

The subtractive grinding process used to create the cutting edges from the intermediate part containing the additively deposited hard material can be carried out on a CNC machine in which the cutting tool preform is machined using a diamond bonded and cBN bonded grinding wheels to the desired configuration. It should be appreciated that the particular cutting and grinding parameters are material and equipment dependent.

The shape and configuration that the cutting tool is machined depends on the desired cutting tool. An example of one cutting tool shape and configuration that may be produced using the process of the present invention is shown in FIG. 16A. As previously described, the cutting tool 400 illustrated in FIG. 16A, comprises a blank 402 onto which the tool material is deposited to form the cutting head 404. The cutting head 404 includes cutting edges 406 formed from the hard material 408 on the outer edges and have an interior composition comprising the inner material 409 (FIG. 16A(D)), which is deposited on and adheres to the blank 402 as described above. The shape of the cutting head 404, including the cutting edges 406 and flutes 410 are formed using a subtractive process as described above.

The process of the present invention can be used to produce a variety of cutting tool configurations. For example, FIG. 16B illustrates an annular cutter 500 configuration that could be produced by the process of the present invention. The annular cutter 500 comprises a cylindrical blank 502 which includes flat sections 503 used to hold the cutter rigid within the cutting tool mount (not illustrated). The hollow cutting head 504 includes cutting edges 506 formed from the hard material on the outer edges and have an interior composition comprising the inner material, which is deposited on and adheres to the head 504 as described above. The shape of the cutting head, including the cutting edges 506, flutes 510, cutting teeth 512 and the cutting cavity 514 are formed using an additive and subtractive process as described above. For this specific embodiment, the annular cutter 500 is formed by the following steps:
Step 1: Turning and drilling of cylindrical bar stock (4140 steel) in an annealed condition (soft machining) to produce a blank with a shank and hollow body section with a selected wall thickness.
Step 2: Additively manufacturing a designed number of cutting teeth deposit bodies using the following process:
   Step a. Building helical teeth deposit bodies along the outside diameter of the blank using inner matrix material for the designed number of teeth using a laser metal deposition (LMD) process as described above.
   Step b. Building end-face teeth deposit bodies on the end section of the blank from inner matrix material using a laser metal deposition (LMD) process as described above.
   Step c. Depositing outer hard material layer on helical teeth deposit bodies using a laser metal deposition (LMD) process as described above.
   Step d. Depositing outer hard material layer on end-face teeth deposit bodies using a laser metal deposition (LMD) process as described above.
Step 3. Post heat treating the helical teeth deposit bodies and end-face teeth deposit bodies on the blank as described above.
Step 4. Subtractive manufacturing the cutting edges—by grinding flutes and lands on the helical teeth deposit bodies to form cutting edges 506 followed by grinding gashes and lands on the end-face teeth deposit bodies to form cutting edges 515 on cutting teeth 512 on the end-face 516 (FIG. 16B).

The present invention can be used to produce cutting tools for machining for materials such as metal, plastic timber and nylon. However, it should be appreciated that the present invention can be used for cutting tools of other materials such as rocks, dental materials, or the like. It should also be appreciated that the present invention can be applied in remote locations provided suitable machinery is available, it allows industries with remote operations (e.g., mining, defence, offshore oil and gas, etc.) to (i) repair items on-site and (ii) carry limited stocks of items that wear out.

Specific examples of application include cutting tools used in hard materials such as:
rocks (2-6 Mohs or 60-1000 HV_{0.5});
dental materials (hardness 90-1250 HV_{0.5}), for example endodontic files and reamers;
carbon fibres (<350 HV_{0.5}) and carbon fibre reinforced composites;
metal matrix composites (<1000 HV_{0.5}).

The present invention could also be used for applications where higher hardness is beneficial than those provided by traditional methods. For example, conventional hardfacing technologies result in hardness values in the range of 385-940 HV_{0.5} (40-65 HRC) and their microstructures are coarser than those obtained with the AM methods. This is because the solidification rates are far greater in AM. Even for the same hardness, a finer microstructure may be able to provide a smoother surface finish since the tool surfaces can wear more uniformly, avoiding rough cutting edges. These considerations indicate that the present invention can provide superior machining performance when compared with the standard hardfacing techniques.

Non-limiting examples of industries where this technology could replace hardfacing including: Mining and resources, wood processing, pulp and paper, general engineering, cement, steel and aluminium, printing, bulk and materials handling, quarries, oil and gas.

It is noted that in some of these applications, base substrate will comprise a blank that has non-cylindrical surfaces. In this respect, it should be appreciated that the base substrate does not necessarily have to have a cylindrical configuration, and that other configurations can be used.

### Repairing, Rebuilding and Resharpening Cutting Tools

It should be appreciated that the above process can also be adapted to repair, rebuilt and/or resharpen a cutting tool, for example a cutting tool where the cutting edge is worn or damaged. That cutting tool may be formed using the process of the present invention, or may be formed using a different process. In such a process, the existing cutting tool undergoes a similar additive deposition step/process as described above, except in this process, at least one layer of a tool material comprising tungsten carbide or tantalum niobium carbide, or a tungsten carbide or tantalum niobium carbide containing alloy or composite is deposited onto one or more cutting edges of a cutting formation of that cutting tool to form a repair deposit thereon. The repair deposit is then subjected to subtractive machining steps to repair or resharpen the at least one cutting formation. That cutting tool is therefore rebuilt or repaired to provide a sharp cutting edge. Thus, where the cutting edges get blunt or damaged, these edges require a small build which can be rebuilt relatively quickly. This rebuilding option can reduce material wastage and the need for expensive recycling. Depending on tool type you could rebuild a tool 10 to 20 times for the cost of a new tool.

Typically, it is only the outer hard material composition that needs to be additively deposited to form the repair deposit in the process over the cutting edge. The tool material in this repair, rebuilding and/or resharpening process of the present invention therefore preferably comprises a hard material as discussed above.

### EXAMPLES

### Example 1—Prototype and Spiral Style Deposits

### 1. Experimental Study Overview

A number of prototype cutting tools were additively manufactured and tested following the process of the present invention. The prototype cutting tools were manufactured using a two-stage process involving:
(A). Additively depositing—using laser cladding—a hard material onto an off-the-shelf steel blank to form a preform tool having roughly the shape and configuration of the desired tool configuration; and
(B) Grinding the preform tool using a CNC machine to obtain the final desired tool configuration and cutting edges. The tools were tested under standard cutting conditions, and their wear performances were compared against those made from traditional materials and processes.

The aim of the study was to move towards creating tools that comprised a additively manufactured hard material deposit having the following ideal properties:
1. A bulk hardness of 1100 HV_{0.5} or greater, preferably 1300 HV_{0.5} or greater;
2. A microstructure that is as homogeneous as possible (for consistent cutting performance, including the possibility of regrinding the deposit up to five times and the ability to rebuild the tool to its original dimensions through re-depositing);
3. No pores that would interfere with cutting quality; and
4. No cracks that will affect its performance.
5. No other defects to be present.

Several permutations and combinations of process parameters associated with laser cladding were identified and investigated to derive processing windows conducive to avoiding cracking defects and limiting porosity defects.

### 2. Materials

The materials to be additively deposited onto an off-the-shelf steel blank are listed below:
Cutting tool substrate: 4140 grade steel tool blank
Inner matrix materials: Metco 1030A (53-150 μm—a martensitic matrix iron alloy with fine scale, extremely hard molybdenum borides and vanadium carbides available from Oerlikon Metco (Australia) Pty. Ltd) and Rockit 706 (53-180 μm—a martensitic iron-based structure with finely dispersed hard vanadium carbides produced by Höganäs AB, Sweden and available from Australian Metal Powder Supplies).
Hard materials: WOKA 50505 (WC-6Co, spherical, 75-125 μm—Cemented Tungsten Carbide Pellets available from Oerlikon Metco (Australia) Pty. Ltd), WOKA 50538 (WC-6Ni, 106-180 μm—Cemented Tungsten Carbide Pellets available from Oerlikon Metco (Australia) Pty. Ltd), WOKA 3111 FC (WC-12Co, 5-20 μm—spheroidal powders for thermal spraying containing 88% WC as a hard material and a cobalt matrix that functions as a binder material for the WC—available from Oerlikon Metco (Australia) Pty. Ltd), WOKA 50051 (WC, 20-53 μm—Spherical Fused Tungsten Carbides (CTC-S) are spheroidally shaped, two-phase tungsten carbide powders available from Oerlikon Metco (Australia) Pty. Ltd) and ultrafine WC/TaNbC.
Combinations: (1) Mixture of inner matrix material and hard material (2) Hard material only or with conventional NiSiB inner matrix material.

The experimental materials and other comparative materials are summarised in Tables 1 and 2:

TABLE 1
Inner Matrix Materials

| | | Published |
|---|---|---|
| Material | Chemistry | Hardness (HV) |
| Metco 1030A | Martensitic matrix with finely dispersed | 772-940 |
| | molybdenum borides & vanadium | |
| | carbides | |
| Metco 1051A | Martensitic matrix with finely dispersed | 746-832 |
| | tungsten borides & niobium carbides | |
| Rockit606 | Martensitic matrix with finely dispersed | 800 |
| | vanadium carbides | |
| Rockit706 | Martensitic matrix with finely dispersed | 865 |
| | vanadium carbides | |
| NanoSteel9290 | Borocarbide phases | >1100 |
| NanoSteel9700 | Borocarbide phases | 900-1034 |

TABLE 2
Hard materials

| Material | Chemistry | Form |
|---|---|---|
| WOKA 50051 (20-53 μm) | W2C—WC | Fused |
| WOKA 50505 (75-125 μm) | WC—6Co | Agglomerated, sintered |
| | | and densified |
| WOKA 50538 (106-180 μm) | WC—6Ni | Agglomerated, sintered |
| | | and densified |
| WOKA 3111 FC (5-20 μm) | WC—12Co | Submicron WC, |
| | | agglomerated and sintered |
| WC DS 80 (0.8-0.9 μm) | WC | Sintering grade |
| TaNb CHGS 80/20 (1 μm) | TaC—NbC | Sintering grade |
| Synthetic Diamond (53-63 | — | — |
| & 200 μm) | | |

### 3. Strategy and Experimental Method

The main goal of this study was to produce a deposit with minimal to zero cracking and porosity defects on deposits as well as producing a matrix hardness value approaching the desired 1300 HV_{0.5}. This included studying the effect of powders and other process parameters correlated, where possible, with microstructural features with microhardness measurements.

The experimental equipment for the additive deposition step is illustrated in FIGS. 1A and 1B. As described above, a Laserline LDF4000-60 system 130 (FIG. 1B) was used to generate the laser beam 132 which was delivered to the optical/laser head 105 through a 0.6 mm diameter optical fibre 107 providing the following parameters: 300 mm FL; 72 mm CL; 2.5 mm Spot Size. The laser head 105 consisted of the optics and a powder feeding nozzle, and these were secured to a Yaskawa Motoman DX200 MH24 robot 110 for the manipulation of the laser beam and the delivery of metal powder. A powder feeder 115 including hopper 117 was separately controlled to deliver the metal powder into a feeding nozzle. The illustrated workpiece 120 comprised a rotary chuck 122 used to hold the tool blank 120 which was spun around under the laser head 105 at a specified distance from the powder feeding nozzle 131 in head 105. The laser beam 132 melted the metal powder on the workpiece surface and thus a coating overlay was formed using this laser cladding process. The system and process were controlled through a computer control system (not illustrated). The base substrate comprised a 10 mm diameter 4140 high tensile steel bar/blank sectioned to a length of 90 mm. The coating overlay was deposited to achieve an overall thickness of 14.5 to 15 mm.

Hardness measurements were made by sectioning the cutting tool longitudinally, polished and etched for metallography and hardness measurement. A Vickers microhardness tester was used with a 2 kg force load to determine hardness values at different locations along the sections tool face.

A large number of process parameters were investigated to determine how to best optimise the hardness of the deposition and reduce porosity and cracking. These parameters are specified for each trial in Table 3, and included but were not limited to:
1. Powder compositions and sizes for the matrix material and hard material;
2. Mixing percentages of the matrix/hard materials;
3. Powder flow rate (approximately 20-35 g/min);
4. Powder delivery method (coaxial vs. side injection) as explained above;
5. Powder delivery characteristics: angle, target location in the melt pool and focal point of the powder injection trajectory—as described in relation to FIG. 6;
6. Substrate preheat temperatures;
7. Laser power ranging from 600 W to 3000 W (including ramping up and/or down);
8. Laser focus;
9. Laser scanning speed (mostly 600 and 1000 mm/min);
10. Laser tool path—in most cases a spiral tool path was followed for deposition on the curved area of the blank;
11. The delay between deposit layers to manage the transient temperature profile in the substrate;
12. Deposit scheme, including depositing only the matrix material for the first few layers followed by only the hard material;
13. The degree of overlap between deposits tracks—mostly 50%; and
14. Use of an Ar enclosure to limit atmospheric O₂ reacting with the deposit during deposition—as illustrated and described in relation to FIG. 5.

During the course of the study, a large number of prototype cutting tools were produced. A selected number of these prototypes cutting tools were ground to create the required cutting edges and tested under standard machining conditions. The parameters for each of these samples, as discussed in the Results and Insights is provided as follows:

TABLE 3
Experimental Parameters for selected prototype cutting tools:

| Trial | | | Powder Hopper Setting | Powder Flow Rate | Laser Power |
|---|---|---|---|---|---|
| No. | Substrate | Powder | (% RPM) | (g/min) | (W) |
| 155 | 4140 Blank | Metco 1030A - | 6.0 (Twin Hopper) - Metco 1030A | 21.0 - Metco 1030A | Preheat 500 W - |
| | | WOKA 3111 FC | 2.4 (Twin Hopper) SI - WOKA 3111 FC | 5.4 - WOKA 3111 FC | Deposition 800 W |
| 174 | 4140 Blank | Metco 1030A - | 7.0 (Twin Hopper) - Metco 1030A | 21.0 - Metco 1030A | Preheat 500 W - |
| 175 | | WOKA 3111 FC | 2.4 (Twin Hopper) SI - WOKA 3111 FC | 5.4 - WOKA 3111 FC | Deposition 800 W |
| 176 | | | | | |
| 177 | | | | | |
| 178 | 4140 Blank | Metco 1030A - | 6.0 (Twin Hopper) - Metco 1030A | 17.5 - Metco 1030A | Preheat 500 W - |
| | | WOKA 3111 FC | 2.4 (Twin Hopper) SI - WOKA 3111 FC | 5.4 - WOKA 3111 FC | Deposition 800 W |
| 196 | 4140 Blank | Metco 1030A - | 7.0 (Twin Hopper) - Metco 1030A | 20.9 - Metco 1030A | Preheat 500 W - |
| 197 | | WOKA 3111 FC | 4.0 (Twin Hopper) SI - WOKA 3111 FC | 10.9 - WOKA 3111 FC | Deposition 800 W |
| 198 | | | | | & 900 W |
| 199 | | | | | |
| 212 | 4140 Blank | Metco 1030A - | 7.0 (Twin Hopper) - Metco 1030A | 20.9 - Metco 1030A | Preheat 500 W - |
| | | WOKA 3111 FC | 4.0 (Twin Hopper) SI - WOKA 3111 FC | 10.9 - WOKA 3111 FC | Deposition 550-500 W |
| | | | | | Ramped |
| 227 | 4140 Blank | Metco 1030A - | 7.0 (Twin Hopper) - Metco 1030A | 20.9 - Metco 1030A | Preheat 500 W - |
| 228 | | WOKA 3111 FC | 4.0 (Twin Hopper) SI - WOKA 3111 FC | 10.9 - WOKA 3111 FC | Deposition 800-600 W |
| 229 | | | | | & 550-450 W Ramped |
| 230 | 4140 Blank | Metco 1030A - | 7.0 (Twin Hopper) - Metco 1030A | 20.9 - Metco 1030A | Preheat 500 W - |
| | | WOKA 3111 FC | 4.0 (Twin Hopper) SI - WOKA 3111 FC | 10.9 - WOKA 3111 FC | Deposition 800-600 W |
| | | | | | & 550-450 W Ramped |

| Trial | Laser Scan Speed | | Overlap | |
|---|---|---|---|---|
| No. | (mm/s) | Deposition Type | % | mm |
| 155 | Preheat 20 | Preheat: Spiral - 35 mm Length - 10 Passes - 100 mm Defocused/Deposition: Spiral - | 50 | 1.2 |
| | Deposition 16.7 | 35 mm Length - 3 Layers - 3 Min Delay Between Layers Layer 1 Metco 1030A - Layer 2 | | |
| | | Metco 1030A - Layer 3 WOKA 3111 FC | | |
| 174 | Preheat 20 | Preheat: Blank Length - Spiral - 35 mm - 10 Passes - 100 mm Defocused/Metco | 50 | 1.2 |
| | Deposition 16.7 | 1030A Matrix Deposition: Blank Length - Spiral - 35 mm - 3 Layers - 3 Min Delay | | |
| 175 | | Between Layers - Blank End - Spiral In To Out - 3 Layers - 10 Secs Between Layers/ | | |
| 176 | | WOKA 3111 FC Hard material Deposition: Blank End - Spiral In To Out - 1 Layer - Blank | | |
| 177 | | Length - Spiral - 37 mm - 1 Layer | | |
| 178 | Preheat 20 | Preheat: Blank Length - Spiral - 35 mm - 10 Passes - 100 mm Defocused/Deposition: | 50 | 1.2 |
| | Deposition 16.7 | Spiral - 35 mm Length - 3 Layers - 3 Min Delay Between Layers - Layer 1 Metco 1030A - | | |
| | | Layer 2 Metco 1030A - Layer 3 WOKA 3111 FC | | |
| 196 | Preheat 20 | Preheat: Blank End - 10 Secs - 100 mm Defocused/Metco 1030A Matrix Deposition: | 50 | 1.2 |
| | Deposition 16.7 | Blank End - Outer Perimeter Layer Before Each Layer - Spiral In To Out - 2 Layers 10 | | |
| 197 | | Sec Delay Between Layers (800 W) - Blank Allowed To Cool/Preheat: Blank Length - | | |
| | | Spiral - 35 mm - 10 Passes - 100 mm Defocused/Deposition: Spiral - 35 mm Length - 3 | | |
| 198 | | Layers - 3 Min Delay Between Layers - Layer 1 Metco 1030A (800 W) - Layer 2 Metco | | |
| | | 1030A (800 W) - Layer 3 WOKA 3111 FC (900 W) - Argon Shroud Over Blank During | | |
| 199 | | Delays - 30 Secs Delay After WOKA 3111 FC Deposition/WOKA 3111 FC Deposition: | | |
| | | Blank End - Outer Perimeter Layer - Spiral In To Out - 1 Layer (900 W) | | |
| 212 | Preheat 20 | Preheat: Blank Length - Spiral - 35 mm - 10 Passes - 100 mm Defocused/Deposition: | 50 | 1.2 |
| | Deposition 16.7 | Spiral - 35 mm Length - 3 Layers - 3 Min Delay Between Layers - Layer 1 Metco 1030A - | | |
| | | Layer 2 Metco 1030A - Layer 3 WOKA 3111 FC (Side Injection Out Of Focus) | | |
| 227 | Preheat 20 | Preheat: Blank Length - Spiral - 35 mm - 10 Passes - 100 mm Defocused/Deposition: | 50 | 1.2 |
| 228 | Deposition 16.7 | Spiral - 35 mm Length - 3 Layers - 3 Min Delay Between Layers 1 & 2 - 2 Min Delay | | |
| | | Between Layers 2 & 3, 3 & 4 - Layer 1 Metco 1030A (800-600 W Ramped) - Layer 2 | | |
| 229 | | Metco 1030A (800-600 W Ramped) - Layers 3&4 WOKA 3111 FC (550-450 W Ramped) | | |
| | | (Side Injection Out Of Focus)- Tub Argon Atmosphere - 2-3% O2 | | |
| 230 | Preheat 20 | Preheat: Blank Length - Spiral - 35 mm - 10 Passes - 100 mm Defocused/Deposition: | 50 | 1.2 |
| | Deposition 16.7 | Spiral - 35 mm Length - 3 Layers - 3 Min Delay Between Layers 1 & 2 - 2 Min Delay | | |
| | | Between Layers 2 & 3 - Layer 1 Metco 1030A (800-600 W Ramped) - Layer 2 Metco | | |
| | | 1030A (800-600 W Ramped) - Layer 3 WOKA 3111 FC (550-450 W Ramped) - (Side | | |
| | | Injection Out Of Focus) - Tub Argon Atmosphere - 2-3% O2 | | |

### 4. Results and Insights

### 4.1—Elimination of Cracking

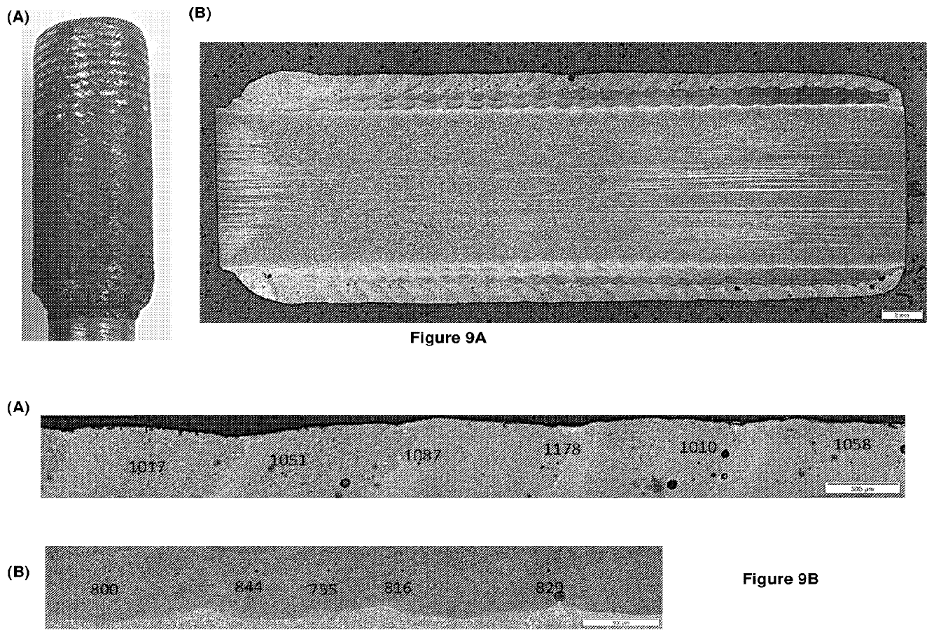

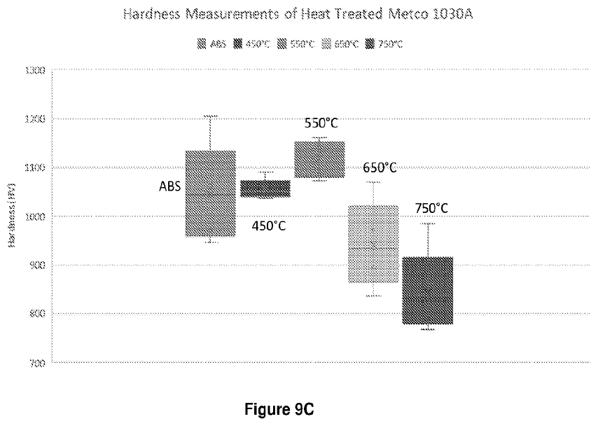

The two main categories of defects found on initial material deposited by laser cladding/laser metal deposition was cracking and porosity. The cracking defect was overcome by introducing a delay of 3 minutes between the deposition of layers—initially on four layers using the Metco 1030A matrix powder. FIG. 9A—which shows Trial 155 where a delay of 3 minutes was introduced to eliminate cracking on the deposits. (The sample shown in 9A has been etched after the deposition for analysis purposes.) It was hypothesised that this action helped thermally manage the substrate temperature to remain at about 250 to 275° C. between the deposits.

### 4.2—Depositing the Hard Material Only where Necessary

Based on the observation that the number of porosity defects was greater when the hard material composition was deposited (both on its own and mixed with the matrix material), the deposition matrix was altered from depositing a mixture of inner matrix material and hard material to depositing the hard material only where the cutting edges would be present. This meant that the initial layers would only consist of a matrix compound (comprising the softer inner matrix material mixed with the material of the base substrate as discussed above)—which will then act as a foundation for the hard material to be deposited on top—for example as indicated in trials 174, 175, 177, 228. The inventors found that this scheme resulted in less porosity defects compared to using hard material (WOKA 3111 FC) alone.

### 4.3—Consistent Hardness Above 1000 HV_{0.5} in the Deposits at Cutting Edge Locations

The adoption of the deposition delay between layers, and selective deposition of the hard material enabled prototypes tools to be produced having hardness of 1000 HV_{0.5} in the final deposit layer where the hard material was laid.

FIG. 4B shows Trial 155 prototype cutting tool where 1000 HV_{0.5} were recorded together with minimal porosity levels was. On this sample, the first two layers consisted of depositing the Metco 1030A matrix material followed by depositing the WOKA 3111 FC hard material. As shown in FIGS. 9B(A) and 9B(B) the different deposition layers have different hardness values, with the first pass Metco 1030A layer (FIG. 9B(B)) having a lower hardness to the outer final pass WOKA3111 FC layer (FIG. 9B(A)).

### 4.4 Gains in Hardness from Bulk Heat Treatment

Nonequilibrium conditions typically prevail during laser cladding (blown powder deposition) because of the rapid nature of the heating, melting and cooling cycles when compared with equilibrium processing. Consequently, the much shorter times available prevent the completion of equilibrium phenomena as outlined below during each stage of the process cycle, as set out in Table 4.

TABLE 4
The different metallurgical phenomena that are
hindered during the laser cladding process

| Process Cycle: | Heating | Melting | Cooling |
|---|---|---|---|
| Metallurgical | Diffusion | Homogenisation | Elemental diffusion |
| phenomena: | of the mixture | of the mixture | and phase formation |

It was discovered that the hardness values of the deposits increased at a certain optimal temperature by heat treating Metco 1030A deposits for 90 minutes in a furnace at various temperatures. It was speculated that this hardness improvement was due to hard precipitates being formed at this temperature.

Heat treating the deposited material can provide an opportunity for some additional reactions to occur. The extra time and energy made available can induce the reprecipitation of hard materials—resulting in increases in matrix hardness. Results from preliminary work is shown in FIG. 9C which shows Hardness achieved on the Metco 1030A deposits after heat treating for 90 minutes at various temperatures in an oven at 450, 550, 650 and 750° C.

This work on Metco 1030A deposits indicated that there was likely to be an optimum temperature and duration for which the layers must be heat treated. As observed from the box plot in FIG. 9C, a heat treatment temperature of 550° C. for 90 minutes gave higher hardness values than lower or higher temperatures for the same soaking time. This was most probably because, at 550° C. for 90 minutes, the hard precipitates formed (probably in greater numbers) but coarsened at higher temperatures, reducing their hardness. The 450° C. temperature, on the other hand, presumably did not provide adequate energy for the reprecipitation to occur.

It should be noted that for all forms of heat treatment, microstructural homogeneity will still need to be achieved along with the avoidance of softening through microstructural coarsening.

### 4.5—the Influence of Argon Atmosphere on Porosity Levels

An optical microscopy investigation of the pores formed in a number of trial samples, for example Trials 174, 175 and 177 shown in FIG. 11, indicated that the pores were well rounded, suggesting the pores were gas pores. A literature review indicated that when cobalt (Co) was present in the cladding material, it could act as an agent for creating gas porosity through reactions with atmospheric oxygen (O₂). Since WOKA 3111 FC hard material had 12% Co, an argon (Ar) shrouding scheme around the laser cladding equipment was employed to provide the shrouding necessary to the molten pool during the manufacturing process. As shown in FIG. 5, the experimental enclosure comprised a polythene bag to enclose the work area fully with a plastic tub acting as a rigid body around the rotator hole. By bagging the system, the O₂ concentration was reduced down to 0.5%. This allowed the entire experiment to be carried out within a low-02 inert-gas atmosphere.

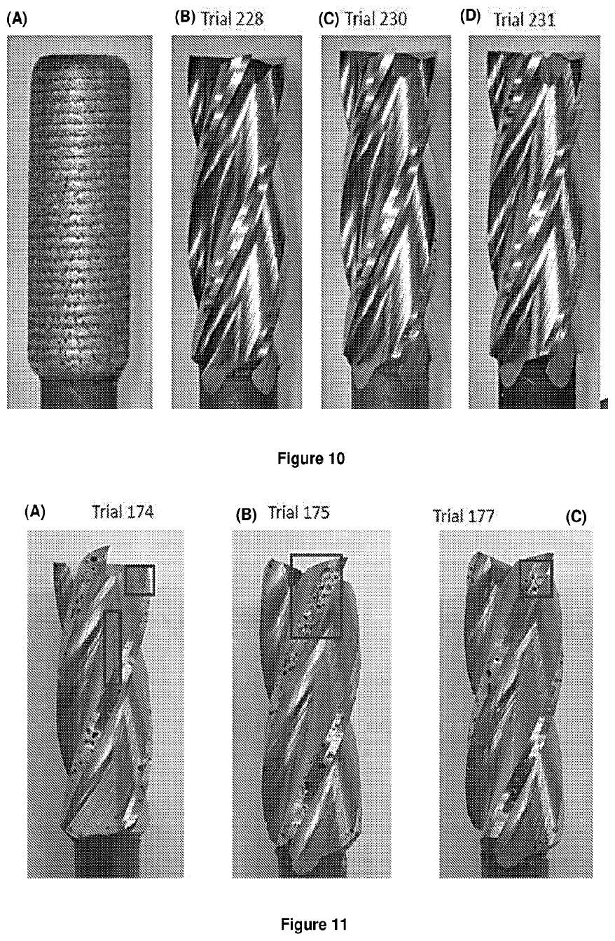

Once an Ar shrouding scheme was in place, porosity levels were almost eliminated, and the results became more repeatable as shown in FIG. 10 for trials 228, 230 and 231 compared with trials conducted without an Ar enclosure—for example trials 174, 175 and 177 shown in FIG. 11.

### 4.6—Consistent Hardness Above 1100 HV_{0.5} at Cutting Edge Locations

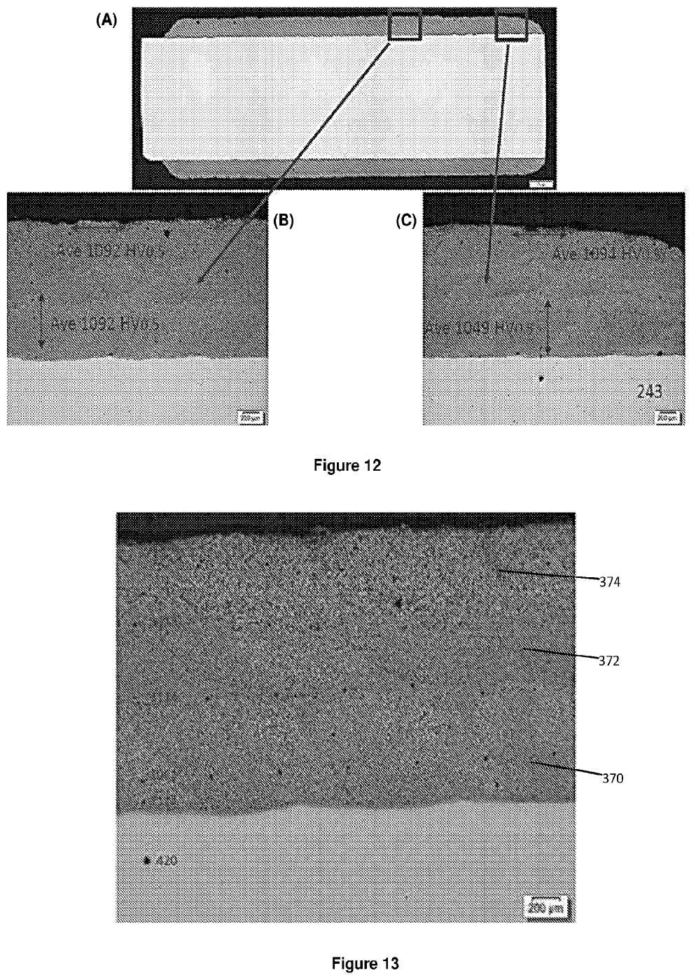

The prototype cutting tool made during Trial 212 (FIG. 12—Trial 212 in which Metco 1030A was deposited in two layers followed by deposition of WOKA 3111 FC (in one deposition step/layer) to form the top deposition layer), were inadvertently produced with the side injection nozzle for the powder delivery out-of-focus—i.e. the powder injection was not focused on the melt pool but rather only generally directed to the tail portion of the melt pool, as shown in FIG. 6C. This blew the powder through the laser beam 132 into the back or tail section 150 of the molten pool 138 (see FIG. 6C). The resulting deposit body exhibited a hardness value of close to 1100 HV_{0.5}. Porosity levels were also low, and no cracking was present. In this trial, the first two layers were the 1030A matrix, and the final layer was the WOKA 3111 FC hard material.

The out-of-focus powder delivery was continued for the rest of the project, (i.e. all trials after Trial 212) resulting in hardness values exceeding 1100 HV_{0.5}—typically of 1100 HV_{0.5} to 1200 HV_{0.5}. For example, Trial 232 (as illustrated in FIG. 13) in which two layers of Metco 1030A (first layer 370, second layer 372) followed by one layer of WOKA 3111 FC (third layer 374), where hardness values of close to 1200 HV_{0.5} were obtained as shown by the hardness values on the images. As illustrated in FIG. 12, the first layer 370 had an average hardness of 1122 HV_{0.5}, the second layer 372 had an average hardness of 1138 HV_{0.5}, and the third layer 374 had an average hardness of 1215 HV_{0.5}.

### 4.7—Insights from Microstructure Analysis and Hardness Testing

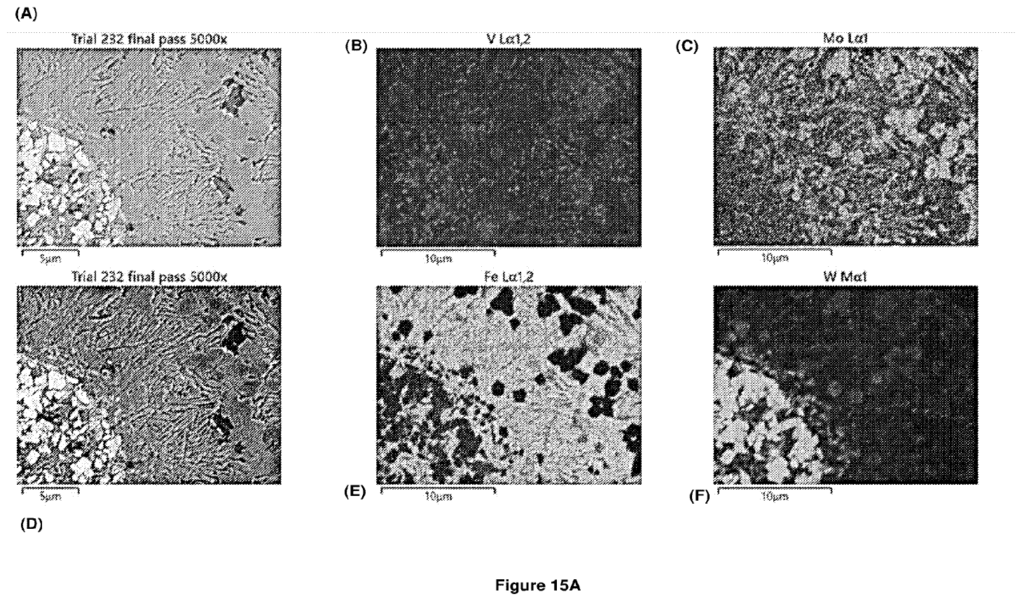

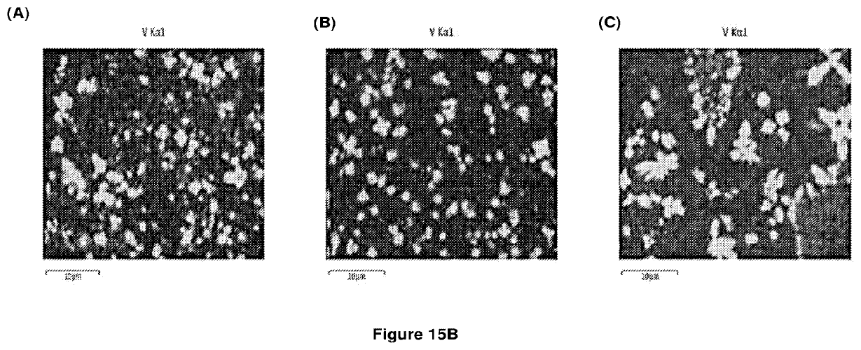

FIG. 14 and FIGS. 15A and 15B provide images and x-ray analysis from a scanning electron microscope (SEM), and a hardness tester—see, for FIG. 14 and FIGS. 15A and 15B for Trial 232. These provided insights that have, in turn, informed the experiments.

FIG. 15A provides SEM images of a cross-section of the cutting tool formed in Trial 232. The colour contrast of the WC agglomerates appearing white clearly identifies their presence in the third layer only. The distribution is not homogeneous, with an increased concentration at the very surface and inter-track regions. The top layer will be removed by machining but the distribution throughout the final layer contributes to the increased hardness.

FIG. 15B provides Xray mapping images of a cross-section of the cutting tool formed in Trial 232 which characterised the location and morphology of phases and, when combined with hardness measurements, helped refine process parameters. The map of the third layer confirms the white agglomerates are WC and presence of Mo and V within a Fe matrix. The V is associated with VC and the Mo can be present as either MoB or part of M23C6 (where W, Mo, or V can be substituted). FIG. 15B specifically tracks the changes of V (implied that it is VC) through the 3 layers of the coating (two Metco1030A and a final layer of WOKA 3111 FC). In the first layer, and close to the substrate, the cooling rate is higher and the VC phases are in evenly distributed, finer more spherodised form. In the final layer V is part of more dendritic phase, due in part to the heat transfer rates of outer layer application but also due to the presence of W.

It was also found that fine vanadium carbides (VC) and molybdenum borides present in the Metco 1030A matrix contributed to the higher hardness of the deposits. As subsequent layers were applied to the blank (i.e., substrate), the morphologies of the phases were found to be affected by the thermal history between layers. The corresponding differences in hardness measurements confirmed these findings. Once the hard material WOKA 3111 FC was applied in the final layer, there were further changes to the microstructure with corresponding variations in hardness measurements.

As seen in FIGS. 14(A), 14(B) and 14(C), the third layer 378 forms a hard compound comprising a dispersion of WC agglomerates 380 within the Metco 1030A matrix material. This hard compound of the third layer 378 is a result of deposition of the hard material (WOKA 3111 FC) in the final layer mixing with the underlying deposited layer (matrix material Metco 1030A) in and around the melt pool (as shown and described above in relation to FIG. 3). The third layer 378 is therefore a combination of the deposited hard material and the underlying matrix compound 382 (i.e. the deposited inner matrix material and base substrate as described previously) Thus, as best shown in FIG. 14A, the third layer 378 produces a composition with WC agglomerates 380 mixed within the matrix compound 382. It should be appreciated that both the first layer 383 and second layer 384 also comprise the matrix compound 382 with a base material composition of the substrate 385 extending through those layers with a gradient of highest concentration in the first layer 382 moving through to a lower concentration in the second layer 384 and further lower within the third layer 378.

### 4.9—Machining Trials

The standard testing methodology involved side milling of mild steel on a HAAS mini mill. Tool wear was measured on the flanks of cutting edges for additively and conventionally manufactured cutting tools to the desired configuration using the following parameters:
Cutting speed: 26 m/min
Feed per tooth: 0.045 mm
Axial depth-of-cut: 14 mm
Radial depth-of-cut: 2 mm
Cut length: 130 mm
Down milling
Emulsion coolant
Measure max flank wear on each tooth every 5 to 10 passes, 5.5 to 11 mins

The tool was ground to the cutting tool shape and configuration shown FIG. 16A.

Wear tests were then performed following the relevant Standards ISO 8688-1 and the salient parameters are listed below:
Workpiece material: 1045 steel (annealed condition 250 HV30).
Cutting Speed: 26 m/min
Axial depth-of-cut: 7 mm
Cut length: 130 mm
Emulsion coolant 5.5-11 mins
Feed per tooth: 0.045 mm
Radial depth of cut: 2 mm
Down milling
Measure flank wear on each outer corner tooth every 5 to 10 passes

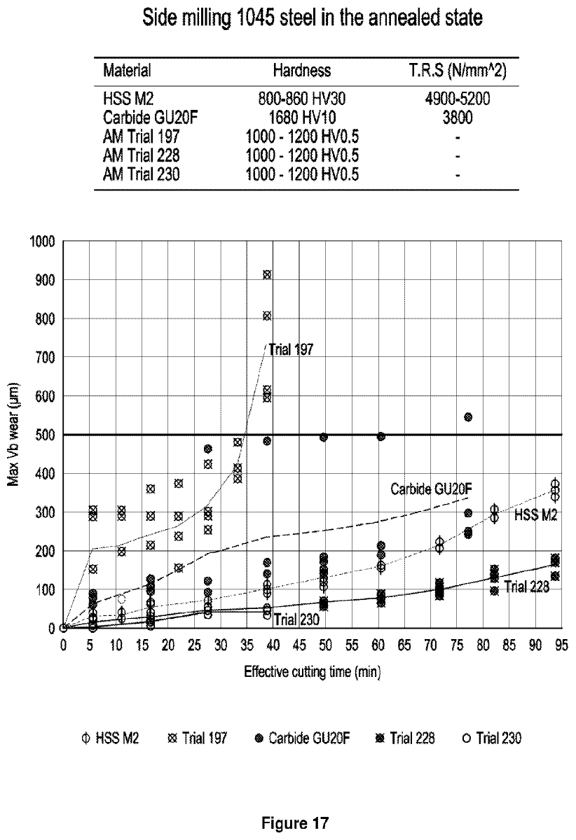

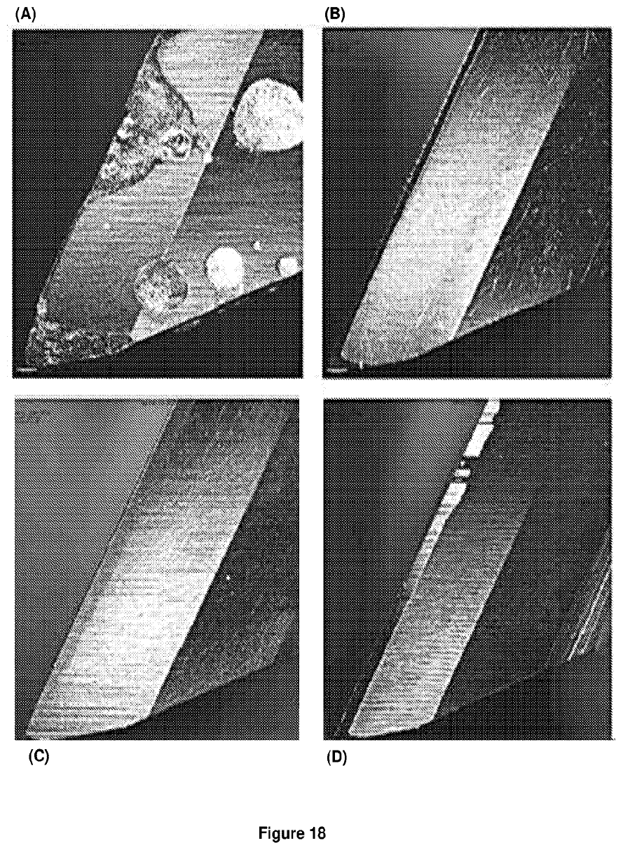

FIG. 17 provides the wear test results obtained from this test for prototypes 197, 228 and 230 along with the traditional tools made of HSS M2 and Carbide GU20F. Prototypes 228 and 230 incorporated the porosity and cracking enhancements. In comparison, prototype 197 was made earlier, before many of the porosity and cracking reduction enhancements were incorporated into the process. The cutting edges after the trials are compared in FIG. 13 for almost 39 minutes of cutting.

FIG. 19 provides further machining trial results following the above methodology. Outer corner wear performance as a function of effective cutting time. HT=Heat Treated. The graph shows the Metco 1030A/WOKA 3111 FC powder mix (black graph) providing the best wear performance (twice as good as the traditional HSS—yellow graph) when heat treated to 550° C. The tool life is shown in Table 5:

TABLE 5
Tool Life of Wear Samples

| Sample Description | Rank and tool life (min) |
|---|---|
| 1030A/3111FC | 1^{st} 57 |
| 1030A As-built | 2^{nd} 42 |
| 1030A/3111FC Trial 228 | 3^{rd} 38 |
| M2 HSS | 4^{th} 27 |

This shows that the wear performance of the final produced cutting tools (trials 227 to 230) is at least 100% better than traditional HSS tools. This is confirmed by the fact that one of our tools (1030A/3111 FC HT 550C—Trial 228) takes more than twice as long to wear the same amount (300 mm) as a traditional M2 HSS tool (yellow graph) as shown in FIG. 17.

### Parametric Summary

A summary of the typical process parameters/values used in the experiments of this AM process are provided in table 6, with the optimum parameters determined in the trials shown in column 3. It is noted that the substrate was always a cylindrical blank of steel 4140 for the purposes of these experiments. The substrate could have a different shape and/or geometry if desired.

TABLE 6
Typical process parameters used in the AM process:

| | | | Values for samples with best results |
|---|---|---|---|
| Process variable | Values | | in terms of hardness and defects |
| Powders | Metco 1030A (initial layer/s) + WOKA | | Metco 1030A + WOKA3111FC |
| | 3111FC (top layer/s); Metco 1030A, WOKA | | combination |
| | 3111FC, Rockit 706, 60% WOKA3111FC + | | |
| | 40% Rockit 706, WOKA 50538, 60% WOKA | | |
| | 50538 + 40% Metco 7010, WOKA 50505, | | |
| | Ultrafine WC + steel 4140, Rockit 606, | | |
| | Metco 1051A, Ultrafine WC, Ultrafine WC | | |
| | Layer with Metco 7010 Layer on Top, 60% | | |
| | Ultrafine WC/40% Metco 7010 Premixed, | | |
| | Ultrafine TaNbC Layer with 4140 Layer on | | |
| | Top, 60% Ultrafine TaNbC/40% 4140 | | |
| | Premixed, Ultrafine TaNbC | | |
| Powder hopper setting | Single Hopper: 1.00 RPM and Twin Hopper: | | Twin Hoppers: Metco 1030A - 7.0 RPM |
| (Revolutions Per Minute | 2.1-8.5 RPM. | | and WOKA 3111FC - 4.0 RPM. |
| or RPM) | | | |
| Powder flow rate (g/min) | 5-4-30.9 | g/min | Metco 1030A - 20.9 g/min and WOKA |
| | | | 3111FC - 10.9 g/min |
| Laser Power (W) for | 500 W (10 passes in a spiral path) when | | Preheated with 500 W (10 passes in a |
| preheating substrate | using preheat. Some early samples were | | spiral path). |
| | not preheated. | | |
| Laser Power (W) for | 300-1000 W (either constant rate, ramp | | Ramp in power from 800 to 600 W for |
| deposition | down/up during deposition) | | the 1030A matrix layers and ramped |
| | | | down from 550 W to 450 W for the |
| | | | WOKA 31111FC hard material layers. |
| Laser scan speed (mm/s) | 20 | mm/s | Same |
| for preheating substrate | | | |
| Laser scan speed (mm/s) | 8-16.7 | mm/s | 16.7 mm/s was used. |

| | | |
|---|---|---|
| for deposition | | |
| Laser focus | Defocused (for an overwhelming majority | Defocused for preheating and focused |
| | of samples) for preheating and focused for | for deposition |
| | deposition | |
| Preheat of the blank (° C.) | The oven temperature was 250° C. The | Same |
| applied in an oven before | substrate would have lost temperature | |
| laser-based preheat was | during transfer from the oven to the chuck, | |
| applied | and during the delay between mounting | |
| | and start of laser-based deposition | |
| Deposit types | Spiral (for an overwhelming majority of | Spiral |
| | samples) | |
| Time delay between | Up to 5 min | 3 min between layers 1 & 2; 2 min |
| depositing layers (to | | between layers 2 & 3 |
| manage substrate | | |
| temperature) (min) | | |
| Measured O₂ percentage in | The Argon enclosure was used towards the | 2-3% |
| the enclosed tub that | end of Stage 2. Previously, although the Ar | |
| contained the workpiece | gas was used to shield the workpiece from | |
| | atmospheric O₂, there was no adequate | |
| | control of the situation | |
| Overlap between tracks | 50%, 1.2 mm | 50%, 1.2 mm |
| (%, mm) | | |

### 5. Conclusion

The final prototype cutting tools made using the technology perform better than traditional HSS tools in terms of wear and exhibited no cracking and minimal porosity. A matrix hardness of 1100 HV_{0.5} to 1200 HV_{0.5} was achieved. The machining trials confirmed that the project prototypes performed better than similar tools made of traditional materials like high-speed steel (HSS) in terms of wear under the same conditions.

### Example 2—Large-Pitch Helical Flute-Style Deposits

### 1. Introduction

The aim of these further experimental runs were to produce cutting tools which optimise the parameters from the previous experimental runs to obtain suitable processing windows which achieve the hardness target, as well as reducing the amount of material deposited. The resulting tools were to have the following characteristics:
1. The AM deposits to be laid in shapes that closely resembled the curved geometries of the cutting edges of tools. These discrete near-net-shape deposits (or helixes) placed on an off-the-shelf steel shank's cylindrical surface were aimed to lower subtractive machining effort compared to spiral deposition path detailed in example 1.
2. The AM deposits to have a microhardness of at least 1300 HV_{0.5} at locations corresponding to the cutting edges.
3. The deposits to be free of defects (e.g., porosity, cracks).

As detailed below, these experimental runs produced a defect-free large-pitch helical flute-style deposits that exceeded the hardness target by creating additive layers with microhardness values around 1500 HV_{0.5}.

### 2. Methodology

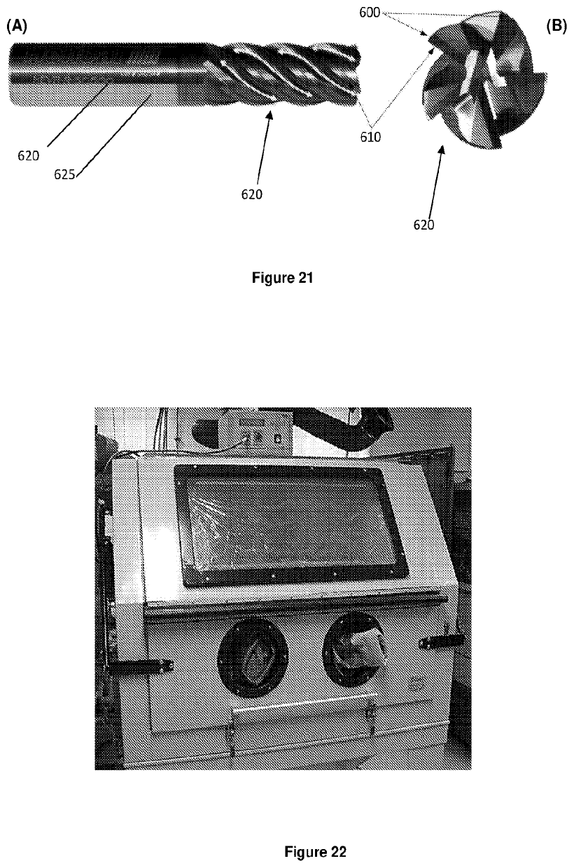

These experimental runs followed from the previous example and used the materials and process parameters as detailed in Example 1. The experimental runs followed the methodology and materials outlined in sections 2 and 3 of Example 1. However, for these experimental runs, the following modifications were made:
1. The deposit shapes were changed from the continuous spirals that completely covered the cylindrical surfaces of the substrate (a 4140 steel shank) to discrete, large-pitch helical flute-like shapes resembling the cutting edges on cutting tools (e.g., end mills)—see for example FIG. 20 and FIG. 21. In FIG. 21, the hard AM deposits correspond to the raised formation 600 on cutting edges 610 of the cutting head 615 of cutting tool 620. The cutting edges 610 are part of the raised formations sandwiched between the helical grooves or flutes and follow their shape along the axis of the shank 625 as shown by the arrows.
2. The axial length of the deposits was reduced from 35 mm to 25 mm for these experimental runs.
3. A permanent inert atmosphere enclosure (FIG. 22) was installed to provide an inert argon atmosphere for cladding (to avoid interactions with atmospheric oxygen). As shown in FIG. 22, the enclosure comprises a modified sandblaster (or glovebox) cabinet. However, it should be appreciated that any sealable enclosure could equally be used. Whilst not shown in FIG. 22, the enclosure accommodated the rotating chuck, powder feeding system and laser system as previously described in relation to FIGS. 1A to 5.
4. A pyrometer was added to the set up within the atmosphere enclosure for monitoring the melt pool and melt pool tail temperature to provide an understanding of the effect of laser power on melt-pool temperatures. This, in turn, assisted with the management of heat load input into the substrate, which acts as a heat sink.
5. Power ramping was not used in these experimental runs to manage the heat accumulation in the tool body. For spiral deposition (Example 1) a power ramping-down strategy was employed for the underlying matrix material and the final layer of hard material. For helical flute-style deposition pattern (near-net-shape tools) the power ramp-down was not required as the laser was on for a comparatively shorter time compared to spiral deposition. However, the laser power was adjusted to manage heat accumulation in the tool body and the deposition quality.

### 2.1 Materials

Cutting tools were produced by repeating the optimal process conditions described in Example 1. The materials used in in these experimental runs were as follows:
1. Cutting tool substrate: steel 4140 cylindrical shanks
2. Hard matrix material: Metco 1030A (53 to 150 μm)
3. Hard phase material: WOKA 3111 FC (WC-12Co) (5 to 20 μm)

### 5.2 Process Parameters Investigated

A large number of process parameters were investigated. These included but were not limited to:
1. Powder flow rate Metco 1030A (20 to 30 g/min);
2. Powder flow rate WOKA 3111 FC (10 to 28 g/min);
3. Powder delivery method: matrix material—four port coaxial nozzles and hard material—side injection;
4. Powder delivery characteristics: angle, target location in and trailing the melt pool, and focal point of the powder injection trajectory;
5. Tool shank preheat temperatures (250 to 300° C.);
6. Laser power ranging from 450 W to 910 W (including ramping up and/or down);
7. Laser scan speed (600 to 1000 mm/min);
8. Laser tool path and 2-axis manipulator programming/communication;
9. The delay between deposits (to manage the transient temperature profile in the substrate);
10. Deposit scheme, including depositing only the matrix material for the first few layers followed by only the hard phase;
11. The degree of overlap between deposits (50 to 80%); and
12. Use of the Ar enclosure (to limit atmospheric O₂ reacting with the deposit during deposition).

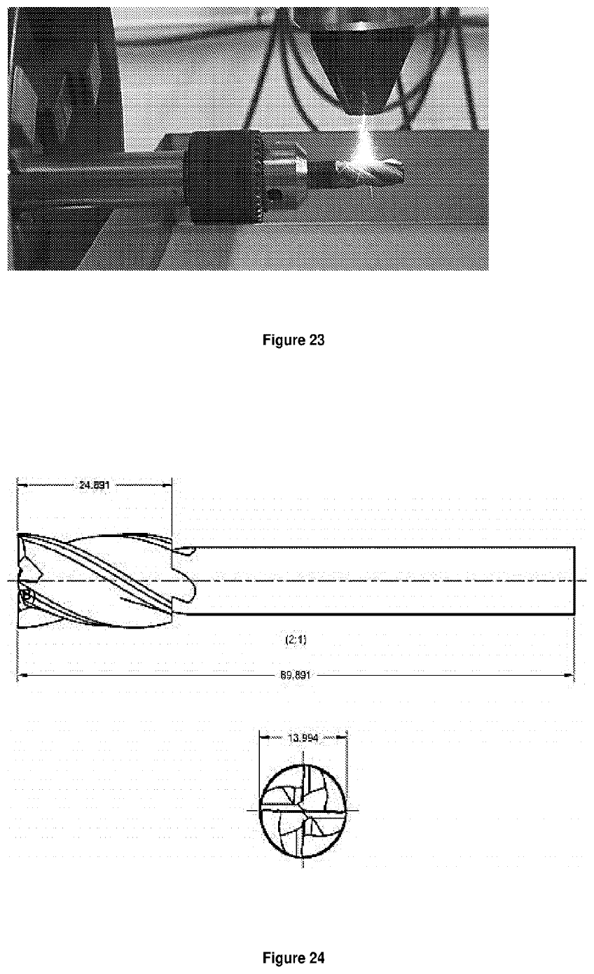

In these runs, examples of the materials and process conditions for exemplified trials are summarised in Table 7. As noted above, the tool path program was changed to deposit large-pitch helical layers as illustrated in FIG. 23:

TABLE 7
Experimental Parameters for selected prototype cutting tools:

| Trial | | | Powder Hopper Setting | Powder Flow Rate | Laser Power |
|---|---|---|---|---|---|
| No. | Substrate | Powder | (% RPM) | (g/min) | (W) |
| 290 | 4140 | Metco 1030A | 7.0 (Twin Hopper) - Metco 1030A | 20.9 - Metco 1030A | Preheat 500 W - Deposition |
| | Blank | | | | 800 W |
| 291 | 4140 | Metco 1030A | 7.0 (Twin Hopper) - Metco 1030A | 20.9 - Metco 1030A | Preheat 500 W - Deposition |
| | Blank | | | | 800 W |
| 361 | 4140 | Metco 1030A - | 8.0 (Twin Hopper) - Metco 1030A | 20.9 - Metco 1030A | Preheat 500 W - Deposition |
| | Blank | WOKA 3111 FC | 4.0 (Twin Hopper) SI - WOKA 3111 FC | 10.9 - WOKA 3111 FC | 800 W & 400 W |
| 400 | 4140 | Metco 1030A - | 8.0 (Twin Hopper) - Metco 1030A | 20.9 - Metco 1030A | Preheat 500 W - Deposition |
| | Blank | WOKA 3111 FC | 4.0 (Twin Hopper) SI - WOKA 3111 FC | 10.9 - WOKA 3111 FC | 800 W &500 W Second layer |
| | | | | | WOKA 3111FC 200 W |
| 411 | 4140 | Metco 1030A - | 8.0 (Twin Hopper) - Metco 1030A | 20.9 - Metco 1030A | Preheat 500 W - Deposition |
| | Blank | WOKA 3111 FC | 4.0 (Twin Hopper) SI - WOKA 3111 FC | 10.9 - WOKA 3111 FC | 800 W & 400 W |
| 415 | 4140 | Metco 1030A - | 8.0 (Twin Hopper) - Metco 1030A | 20.9 - Metco 1030A | Preheat 500 W - Deposition |
| | Blank | WOKA 3111 FC | 4.0 (Twin Hopper) SI - WOKA 3111 FC | 10.9 - WOKA 3111 FC | 800 W & 500 W |
| 419 | 4140 | Metco 1030A - | 8.0 (Twin Hopper) - Metco 1030A | 20.9 - Metco 1030A | Preheat 500 W - Deposition |
| | Blank | WOKA 3111 FC | 4.0 (Twin Hopper) SI - WOKA 3111 FC | 10.9 - WOKA 3111 FC | 800 W & 600 W |
| 423 | 4140 | Metco 1030A - | 8.0 (Twin Hopper) - Metco 1030A | 20.9 - Metco 1030A | Preheat 500 W - Deposition |
| | Blank | WOKA 3111 FC | 6.0 (Twin Hopper) SI - WOKA 3111 FC | 17.7 - WOKA 3111 FC | 800 W & 600-700 W |
| 425 | 4140 | Metco 1030A - | 8.0 (Twin Hopper) - Metco 1030A | 20.9 - Metco 1030A | Preheat 500 W - Deposition |
| | Blank | WOKA 3111 FC | 8.0 (Twin Hopper) SI - WOKA 3111 FC | 27.6 - WOKA 3111 FC | 800 W & 600-700 W |
| 429 | 4140 | Metco 1030A - | 8.0 (Twin Hopper) - Metco 1030A | 20.9 - Metco 1030A | Preheat 500 W - Deposition |
| | Blank | WOKA 3111 FC | 8.0 (Twin Hopper) SI - WOKA 3111 FC | 27.6 - WOKA 3111 FC | 800 W 600-700 W |
| 431 | 4140 | Metco 1030A - | 8.0 (Twin Hopper) - Metco 1030A | 20.9 - Metco 1030A | Preheat 500 W - Deposition |
| | Blank | WOKA 3111 FC | 8.0 (Twin Hopper) SI - WOKA 3111 FC | 27.6 - WOKA 3111 FC | 800 W 600-700 W |
| 442 | 4140 | Metco 1030A - | 8.0 (Twin Hopper) - Metco 1030A | 20.9 - Metco 1030A | Preheat 500 W - Deposition |
| | Blank | WOKA 3111 FC | 4.0 (Twin Hopper) SI - WOKA 3111 FC | 10.9 - WOKA 3111 FC | 800 W & 500 W |

| | | |
|---|---|---|
| Trial | Laser Scan Speed | Overlap |

| No. | (mm/s) | Deposition Type | % | mm |
|---|---|---|---|---|
| 290 | Preheat 20 | Preheat: 25 mm Length - 10 Passes - 100 mm Defocused/Deposition: Flute - 25 mm | 50 | 1.2 |
| | Deposition 16.7 | length - 2 Layers 2 tracks 0° Helix Angle - straight Flute | | |
| 291 | Preheat 20 | Preheat: 25 mm Length - 10 Passes - 100 mm Defocused/Deposition: Flute - 25 mm | 50 | 1.2 |
| | Deposition 16.7 | length - 2 Layers 2 tracks 0° Helix Angle - straight Flute | | |
| 361 | Preheat 20 | Preheat: 25 mm Length - 20 Passes - 100 mm Defocused/Deposition: Flute - 25 mm | 80 | 1.92 |
| | Deposition 16.7 | length - 2 Layers - Layer 1 Metco 1030 A (800 W) 2 tracks - Layer 2 WOKA | | |
| | | 3111FC(400 W) 1 track - 30° Helix Angle - 0.5 to 1.2% O2 | | |
| 400 | Preheat 20 | Preheat: 25 mm Length - 20 Passes - 100 mm Defocused/Deposition: Flute - 25 mm | 80 | 1.92 |
| | Deposition 16.7 | length - 3 Layers - Layer 1 Metco 1030 A (800 W) 2 tracks Alternating- Layer 2 WOKA | | |
| | | 3111FC(500 W) 1 track - Layer 3 WOKA 3111 (200 W) - 30° Helix Angle - 0.5 to 1.2% O2 | | |
| 411 | Preheat 20 | Preheat: 25 mm Length - 20 Passes - 100 mm Defocused/Deposition: Flute - 25 mm | 80 | 1.92 |
| | Deposition 16.7 | length - 2 Layers - Layer 1 Metco 1030 A (800 W) 2 tracks - Layer 2 WOKA | | |
| | | 3111FC(400 W) 1 track - 30° Helix Angle - 0.5 to 1.2% O2 | | |
| 415 | Preheat 20 | Preheat: 25 mm Length - 20 Passes - 100 mm Defocused/Deposition: Flute - 25 mm | 80 | 1.92 |
| | Deposition 16.7 | length - 2 Layers - Layer 1 Metco 1030 A (800 W) 2 tracks - Layer 2 WOKA | | |
| | | 3111FC(500 W) 1 track - 30° Helix Angle - 0.5 to 1.2% O2 | | |
| 419 | Preheat 20 | Preheat: 25 mm Length - 20 Passes - 100 mm Defocused/Deposition: Flute - 25 mm | 80 | 1.92 |
| | Deposition 16.7 | length - 2 Layers - Layer 1 Metco 1030 A (800 W) 2 tracks - Layer 2 WOKA | | |
| | | 3111FC(600 W) 1 track - 30° Helix Angle - 0.5 to 1.2% O2 | | |
| 423 | Preheat 20 | Preheat: 25 mm Length - 20 Passes - 100 mm Defocused/Deposition: Flute - 25 mm | 80 | 1.92 |
| | Deposition 16.7 | length - 2 Layers - Layer 1 Metco 1030 A (800 W) 2 tracks - Layer 2 WOKA | | |
| | | 3111FC(600 W) 1 track - 30° Helix Angle - 0.5 to 1.2% O2 | | |
| 425 | Preheat 20 | Preheat: 25 mm Length - 20 Passes - 100 mm Defocused/Deposition: Flute - 25 mm | 80 | 1.92 |
| | Deposition 16.7 | length - 2 Layers - Layer 1 Metco 1030 A (800 W) 2 tracks - Layer 2 WOKA | | |
| | | 3111FC(700 W) 1 track - 30° Helix Angle - 0.5 to 1.2% O2 | | |
| 429 | Preheat 20 | Preheat: 25 mm Length - 20 Passes - 100 mm Defocused/Deposition: Flute - 25 mm | 80 | 1.92 |
| | Deposition 16.7 | length - 2 Layers - Layer 1 Metco 1030 A (800 W) 2 tracks - Layer 2 WOKA | | |
| | | 3111FC(600 W) 1 track - 30° Helix Angle - 0.5 to 1.2% O2 | | |
| 431 | Preheat 20 | Preheat: 25 mm Length - 20 Passes - 100 mm Defocused/Deposition: Flute - 25 mm | 80 | 1.92 |
| | Deposition 16.7 | length - 2 Layers - Layer 1 Metco 1030 A (800 W) 2 tracks - Layer 2 WOKA | | |
| | | 3111FC(700 W) 1 track - 30° Helix Angle - 0.5 to 1.2% O2 | | |
| 442 | Preheat 20 | Preheat: 25 mm Length - 20 Passes - 100 mm Defocused/Deposition: Flute - 25 mm | 80 | 1.92 |
| | Metco | length - 2 Layers - Layer 1 Metco 1030 A (800 W) 2 tracks - Layer 2 WOKA | | |
| | 1030A 16.7 | 3111FC(500 W) 1 track - 30° Helix Angle - 0.5 to 1.2% O2 | | |
| | WOKA 3111FC 16.7 | | | |

### 2.3 Characterisation

The AM deposited flutes and the final cutting tools underwent a series of characterisation measurements to determine the relationships between hardness values and the underlying microstructures and the deposits' microstructural homogeneity (or lack thereof). These tests included:
1. Hardness measurements—methodology as described below (section 2.4); and
2. Metallurgical investigations using an optical microscope and high-end scanning electron microscope (SEM). The scanning electron microscopes used were: a Zeiss Merlin FESEM (Field Emission SEM), a Hitachi TM3030Plus Tabletop SEM and a Zeiss Sigma 300VP (Field Emission SEM).

This characterisation study also helped determine whether the laser power used was sufficient to convert the materials contained in the powders (i.e., hard materials and matrix materials) into desirable microstructures in the additive layers.

### 2.4 Vickers Hardness HV_{0.5} and HV2 Testing

Vickers hardness testing on samples produced in Examples 1 and 2 was conducted using a hardness testing machine—a Buehler Micromet Microhardness Tester following the standard hardness procedure (SWI) for this machine using either a 0.5 kg load which provided an indentation of the order of 30 μm or a 2 kg load which resulted in a larger indent of the order of 60 μm. An investigation using a standardised reference block for hardness testing from AIDI HYOGO Japan found that there was good correlation between the results using the 0.5 kg and 2 kg loads. It should be noted that in all cases the hardness results are indicative only.

Hardness measurements have been used as an indicative value for good mechanical properties where the presence of Carbon (C), Chromium (Cr), Molybdenum (Mo), carbides, Tungsten (W) and Vanadium (V), are contributing to the hardness or strength of the steel. In all cases, the hardness results are indicative only. In most cases the nominal hardness has been derived by only a few indentations.

### 2.5 Tool Dimensions and Shape

The final dimensions of the cutting tool for these experimental runs, after grinding but before machining trials commenced, are shown in FIG. 24. It should be appreciated that the cutting tool used in these trials was selected for these experiments, and that various other cutting tool designs could be used, as discussed previously.

To produce each of the four cutting flutes, a helical deposit was added to the steel 4140 cylindrical shank following a helical deposition path. As can be understood in the art, this helical deposition path for AM material deposition can be programmed using a variety of commercially available tools, and involves synchronisation between the robot controlling powder deposition, the laser beam and the tool rotator during manufacture.

For AM deposition, four deposits were laid on each cylindrical shank, with each deposit having multiple layers—usually two, with the first layer made of the matrix material Metco 1030A and the final layer containing the hard material powder WOKA 3111 FC. An example of the layers for one deposition is illustrated in FIG. 25.

As shown in FIG. 25, two layers of matrix material Metco 1030A (M1 and M2) is deposited along a helical path over the steel 4140 cylindrical shank S1, the second Metco 1030A track M2 having a center C2 offset from the center C1 of the first Metco 1030A track M1. The deposition of the second Metco 1030A track M2 causes a first remelt region R1 in the overlapping section of the two deposit tracks. A deposition track of the hard material powder WOKA 3111 FC W1 is then added over the top of the two Metco 1030A tracks M1 and M2 centred on track center C3. This creates a second remelt region R2 in the overlapping section of the two deposit tracks. In the final three layer deposit, there is a gradient of hard material from the top of the hard material powder WOKA 3111 FC track W1 with reducing concentration further into the remelted region. There is a high concentration of hard material in the upper region W2 of the hard material powder WOKA 3111 FC track W1.

Depositing material in one direction only can lead to inconsistencies in height between the start and end of the deposit, particularly for multilayer deposition as there is an overlap between tracks which can highlight these height differences. Accordingly, deposition direction was alternated between tracks and layers to obtain improved evenness in height along the length of the deposit and provide a more consistent tool diameter.

### 2.6 Subtractive Machining Trial Parameters

Again, the standard testing methodology involved side milling of mild steel on a HAAS mini mill. Each cutting tool was machined to the desired configuration using the following parameters (unless otherwise indicated):
1. Workpiece material: 1045 steel
2. Cutting speed: 26 m/min or 40 m/min
3. Feed per tooth: 0.030 mm
4. Axial depth-of-cut: 6 mm
5. Radial depth-of-cut: 2 mm
6. Cut length: 130 mm
7. Machining type: Down milling
8. Coolant: Emulsion
9. Measurement of wear: Maximum flank wear on each tooth every 5 to 10 passes, 5.5-11 min

The tool was ground to the cutting tool shape and configuration shown FIG. 24.

### 3. Results

### 3.1 Optimum Deposit Strategy for Avoiding Porosity—Matrix Material as the Undercoat

Samples made using one initial layer of Metco 1030A followed by one WOKA 3111 FC layer gave the optimum results in terms of microstructure, hardness and avoidance of defects. The matrix material (Metco 1030A) acted as the ideal substrate for the deposition of the hard layer (WOKA 3111 FC). The tools produced in these experimental runs with nominal process parameters were defect-free and met the milestone hardness requirement of 1300 HV_{0.5}. The depth of this hard region was of the order of 200 μm.

An increase in the depth of the hard layer is desirable to prolong the cutting tool's life and by enabling resharpening while maintaining a wear-resistant surface. Ways were explored for increasing this depth. When an additional (or second) layer of WOKA was attempted as the third overall layer, however, porosity and lack of fusion defects were visible on the third layer.

Process parameters such as laser power, scan speed and powder flow rate were varied to find an optimised processing window—but with limited success. In addition, when the Metco and WOKA materials were alternated, the hardness of the deposits decreased. This was most likely owing to the dilution of the hard material in the layers.

In each set of experiments, selected samples were sectioned to assess the integrity of the deposits.

### 3.2 Use of the Argon Enclosure

As with the experimental trials conducted in Example 1, deposits made inside the argon enclosure generally gave better results in terms of reduced porosity, most likely because reactions with atmospheric oxygen were curtailed.

### 3.3 Preheat Strategy for Avoiding Cracks

For spiral deposition exemplified in Example 1, the laser is continuously on for the continuous deposition process, allowing heat to be maintained in the system. For flute-style deposition of helical layers in these experimental runs, the laser was operated in a sequence where the laser beam switching on for each discrete layer deposition and off in between deposition strips. The on/off strategy allows for heat conduction away from the deposition zone during the pause in deposition between layers. However, this on/off strategy also encourages cracking of the deposited layers.

To overcome some heat loss, the steel tool shank was preheated prior to deposition using the laser for 20 passes at 500 W and defocused by 100 mm to achieve a temperature of 250 to 300° C. In this case, the focal point was above the substrate.

### 3.4 Optimum Heat Treatment Temperature

Samples made using Metco 1030A as the matrix material and WOKA 3111 FC as the hard material were heat treated in an oven at temperatures of 450, 550, 650 and 750° C. for 90 minutes. As found in Example 1, the best wear results were obtained from the tool treated at 550° C., which was thus the optimum temperature to provide sufficient energy to precipitate hard phases in the microstructure. At higher temperatures, the microstructure coarsened, with an associated loss of hardness.

### 3.5 Settings for Improved Dimensional Tolerances

A net tool diameter of 12.0 mm was specified for cutting trials. To achieve this, a target deposition of 12.2 mm was sought to minimise the amount of hard material being subsequently ground off. The main parameters investigated were the number of Metco 1030 A layers and the track overlap.

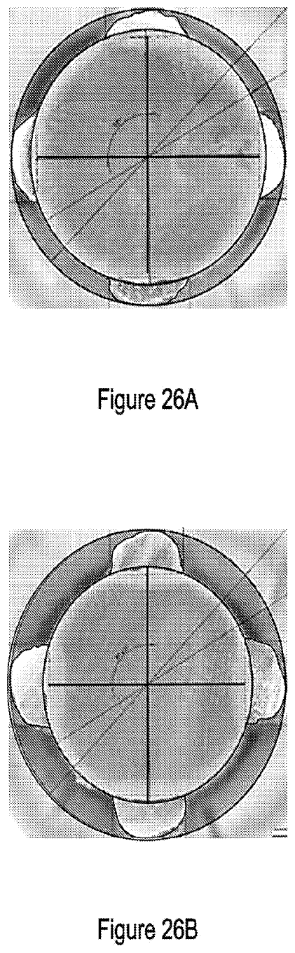

It was found that a single-layer, two-track deposit with 80% overlap between tracks of Metco 1030 A and a single-layer, single-track of WOKA 3111 FC achieved this (FIG. 26(A)—Trial 290). In contrast, double-layer, two-track deposit with 80% overlap between tracks of Metco 1030 A and a single-layer, single-track of WOKA 3111 FC fell outside the desired dimensional tolerances (FIG. 26(B)—Trial 291).

### 3.6 Subtractive Machining of AM Deposit

The parameters used for machining trials for testing the wear performance of tools were as follows:
Workpiece material: 1045 steel
Cut length: 130 mm
Machining type: Down milling
Coolant: Emulsion
Measurement of wear: Maximum flank wear on each tooth every 5 to 10 passes, 5.5 to 11 minutes.

Further parameters are given in Table 8:

TABLE 8
Milling parameters used during cutting tool performance tests.

| | | | | Feed per | | |
|---|---|---|---|---|---|---|
| | Tool | Depth of cut (mm) | | tooth | Cutting | Table |
| | Diameter | aₐ | aᵣ | (mm/ | Speed | Feed |
| Test | (mm) | (axial) | (radial) | tooth) | (m/min) | (mm/min) |
| 1 | 12 | 6 | 2 | 0.045 | 26 | 118 |
| 2 | 12 | 6 | 2 | 0.030 | 40 | 127 |
| 3 | 12 | 6 | 2 | 0.045 | 26 | 118 |

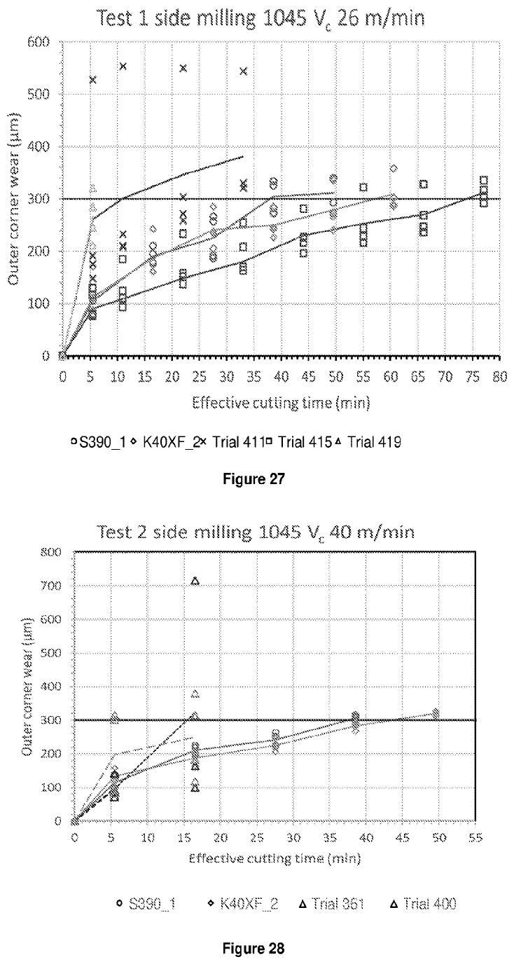

Square end-mills ground from materials S390 PM HSS, K40XF sintered WC (AM trials 415 and 411) were observed to wear uniformly along all cutting edges and at the outer corner during subtractive test 1 (FIG. 27), with the exception that some major and minor outer corner chipping was observed on one cutting edge for trials 411 and 415, respectively. In contrast, the end-mill from trial 419 was observed to wear via significant non-uniform chipping of the cutting edges. The end-mill from trial 415 was measured to have the longest tool life of ˜74 minutes, followed by the K40XF sample at ˜52 minutes and the S390 sample at ˜38 minutes. Regarding trial 411, if the cutting edge which failed after 5.5 minutes is excluded from the average, the tool life at failure is ˜27 minutes. Although the end-mill from trial 419's average outer corner wear did not cross the failure criterion, the tool can be considered to have failed due to the significant chipping along all primary cutting edges.

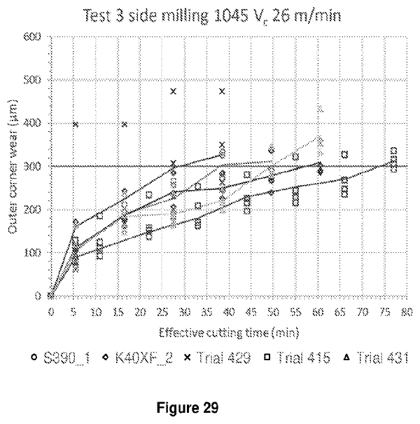

Subtractive Test 2 (FIG. 28) was designed to qualitatively characterise the fracture toughness of AM tools compared to conventionally produced cutting tool materials. The milling parameters in test 2 caused significantly more vibration compared to the parameters in test 1. Outer corner wear measurements reveal significant chipping for the end-mills from AM trials 361 and 400. In contrast, control cutting tools S390 PM HSS and K40XF made from sintered tungsten carbide showed no signs of chipping at the outer corner. All cutting edges were observed to wear uniformly.

Outer corner wear results from subtractive test 3 (FIG. 29) reveal that the end-mill from AM trial 429 performed poorly. One cutting edge was observed to fail catastrophically within 5.5 minutes. A micrograph of the end-face (not illustrated) showed that a pore near the cutting edge reduced the integrity of the edge, causing failure. If this cutting edge is removed from the data set, the end-mill from trial 429 has a tool life equal to S390 of ˜33 minutes. The end-mill from trial 431 performed better than that from trial 429, with a tool life of ˜50 minutes.

### 3.7 Eliminating the Porous Outer Layer of the Hard Deposits

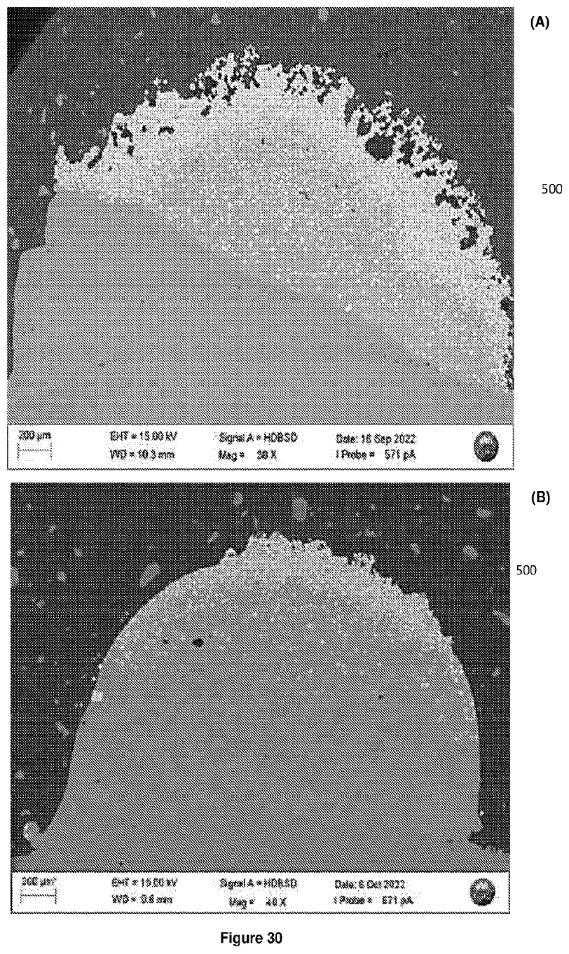

The experimental trial found that a certain set of process parameters produced a porous outer layer at the edge of the deposit. FIG. 30 shows one example, where the top WOKA layer in FIG. 30(A) (trial 423-17.7 g/min WOKA) includes a significant spongy area 500, compared for example with FIG. 30(B) trial 442 (10.9 g/min WOKA) which has a much smaller outer spongy area 500.

The main difference between trial 423 and 442 is the placement of the WOKA 3111 FC track during deposition. The backscattered images of cross-sections Trial 423 shown in FIG. 30(A) has a tilted appearance to the WOKA layer due to the angle of application. The angle of application of the WOKA layer was changed in subsequent trials from 0 degrees to negative 5 degrees and the image in FIG. 30(B) of trial 442 shows the WOKA layer is more symmetrical, with a much lower spongy region 500.

The presence of this porous/spongy layer at the edge was found to have implications for the grinding to produce the final profile of the tool. If insufficient material is removed, the ground surface will contain porosity. If grinding to remove the porous layer is too deep, the hard layer with concentrated WC agglomerates will be removed. Both results will lead to premature wear of the tool.

### 3.7.1 Defined Regions in the Deposit

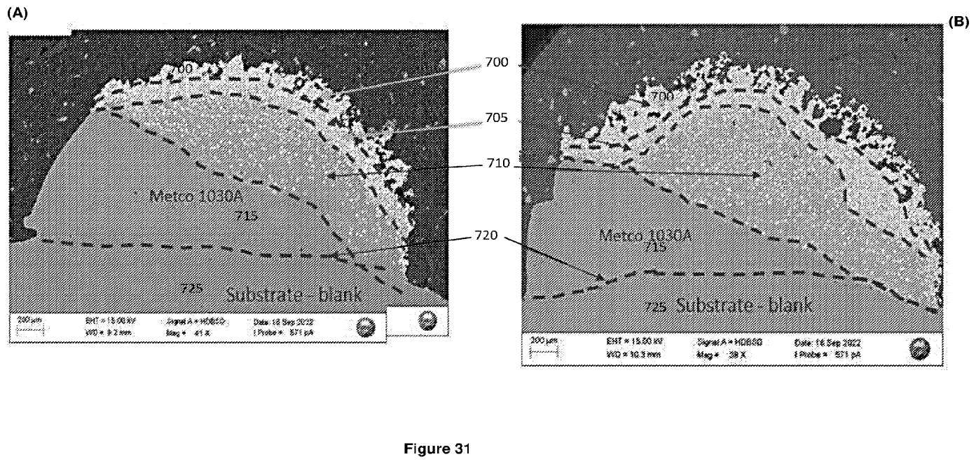

Examination of sample cross-sections showed distinctive regions within the deposit. Selected samples produced in trials were sectioned to examine the integrity (both for defects and carrying out hardness measurements), the shape and dimensions of the deposit and variations in microstructure through the section. Imaging the samples with backscattered electron imaging allowed clear identification of four defined regions within the deposit, as shown in FIG. 31:
spongy/porous outer layer 700,
dense or concentrated WC region 705,
transition region 710, and
Metco 1030A base 715.

It is noted that the broken lines in each image suggests the borders between each region listed above. The deposit interface 720 where the additively manufactured deposit interfaces with the steel substrate 725.

Hardness measurements were made in the polished sections and further information was able to be obtained from the location of the indentations. Analysis of the individual sections showed a high concentration of WC agglomerates in both the spongy/porous outer layer 700 and the concentrated WC region 705. Hardness measurements within both the spongy and concentrated region show values greater than 1300 HV_{0.5}.

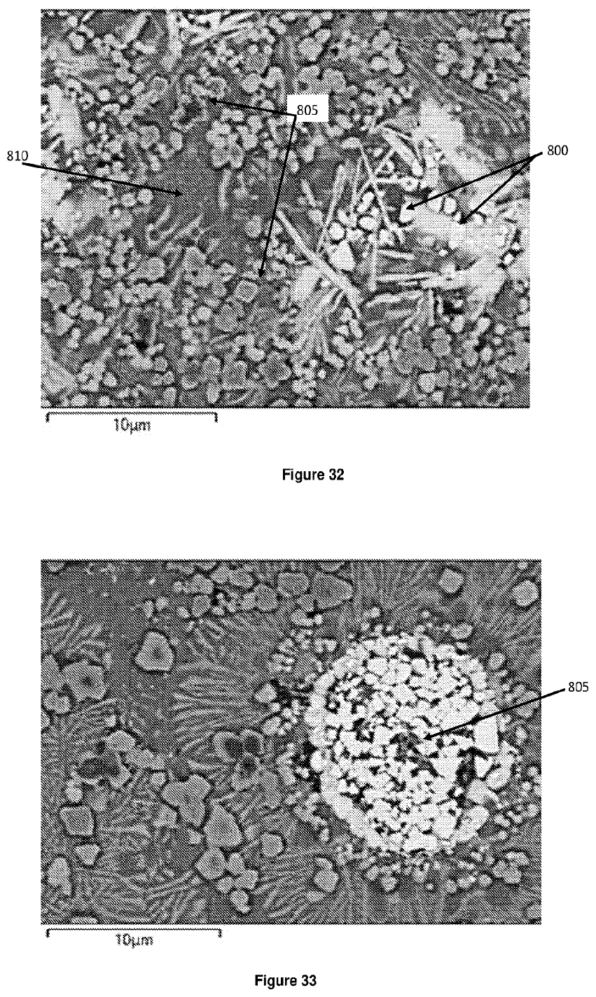

X-ray mapping (results not illustrated) provide quantitative information about elemental distribution. The microstructure within the concentrated region contains a complicated mixture of tungsten carbide (for example 800), VC (for example 805) and M23C7 within a Fe matrix (for example 810). The backscattered electron image in FIG. 32 of the concentrated region from trial and associated X-ray mapping (not illustrated) found the presence of W containing carbides throughout the concentrated WC region. V containing phases are also dispersed throughout the region. The high concentration of carbides and evidence of Co and W in solid solution contribute to higher hardness measurements in this zone. The needle-like precipitates in the microstructure shown FIG. 32 may also act as efficient obstacles in slip planes compared with the fine rounded precipitates in the transition zone and base, also contributing to higher hardness.

The transition zone showed a few agglomerates dispersed within the matrix. Dissolution of W into the matrix increases the hardness and has more of an effect when W not already present.

There is a clear reaction zone around the agglomerates (see FIG. 33 showing a backscattered electron image of the transition region from trial 425) where VC has nucleated from the melt. Again, the presence of W and Co in solid solution improves the hardness. Since there is a lower concentration of the agglomerates in this zone, implying there is less W in solid solution, there is a marked decrease in hardness values from the concentrated zone. A W map (not illustrated) of the microstructure shown in FIG. 33 found W to be concentrated in the undispersed, and isolated, agglomerate (805) and a concentration of V-containing phase surrounding the WC agglomerate.

A further reduction in hardness is measured in the base Metco 1030A region. There is no W found in the base material suggesting that the dilution has not extended into this region.

### 4. Post-Processing

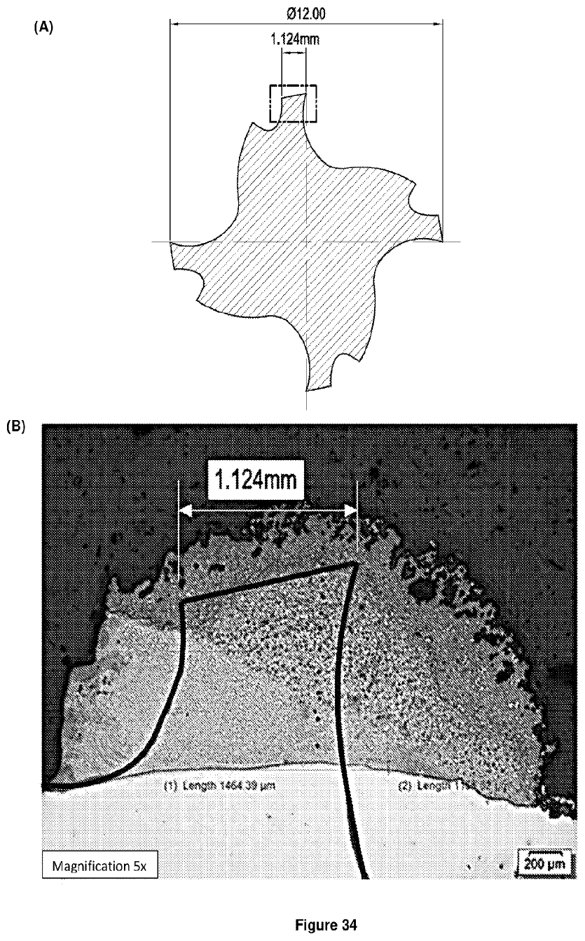

The importance of characterising and measuring the regions within the cross-section is related to the machining profile (See FIG. 34). The spongy/porous outer layer provides a spongy appearance to the outer surface of the deposit when using certain processing parameters. The inconsistent thickness of the deposit needed to be removed so that a pore free surface was left after machining. The pores were not only cosmetically unsatisfactory but act as sites for premature wear. A base layer of Metco 1030A was applied in all cases at a laser power of 800 W.

The helix design is advantageous over the spiral design exemplified in Example 1 as it is closer to final shape alternative, and hence less machining was required. The machining creates the profile for the cutting tool. FIG. 34(b) shows a sketch of the tool profile and has that superimposed over an image of a cross-section. As shown, the concentrated region is intended to be at the top machined surface to provide high hardness, and hence, provide greater wear resistance extending the life of the tool. Ideally any spongy area would not be present in the final machined cross-section. If a spongy area is present after the build, it will need to be machined off. If the concentrated region is removed by the cleaning up process, then the transition zone will be exposed. In some cases, the transition zone has a hardness close to the 1300HV_{0.5}

Accordingly, appropriate process parameters are required to eliminate, or reduce, this porous layer in deposits while also developing a good hardness profile.

### 5. Conclusion

The experimental trials produced cutting tools with cutting edges that exceeded the hardness of 1300 HV_{0.5}.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A process of forming a cutting tool comprising the steps of:
additive deposition of a tool material comprising at least one of: tungsten carbide, TaNbC, a tungsten carbide containing alloy or composite, or a TaNbC containing alloy or composite onto a base substrate having a longitudinal axis, said tool material being deposited onto the base substrate to form a deposit body configured to form at least one cutting formation therein; and
subsequently subtracting selected portions of the deposit body to produce at least one cutting formation having a selected cutting edge configuration, thereby forming the cutting tool.

2. A process according to claim 1, wherein the additive deposition process comprises at least one of: a laser metal deposition (LMD) process, or a directed energy deposition (DED) process.

3. A process according to claim 1, wherein the cutting formation can include at least one flute, blade, protrusion, ledge, ramp, depression, or channel.

4. A process according to claim 1, wherein the deposit body comprises at least one of:
a near-net shape of the at least one cutting formation, preferably the deposit body comprises at least one flute deposited in a spiral or helical path on the base substrate; or
a substantially cylindrically shaped body.

5. (canceled)

6. (canceled)

7. A process according to claim 1, wherein the tool material comprises at least one of WC, TaNbC, or a metal matrix composite comprising at least one of WC or TaNbC, in combination with at least one of Co or Ni.

8. A process according to claim 1, wherein the tool material comprises at least two material compositions comprising an inner matrix material and a hard material which is deposited over the inner matrix material, optionally at least one layer of the inner matrix material and at least one layer of the hard material is additively deposited, and optionally wherein the inner matrix material comprises a martensitic iron alloy with molybdenum borides and vanadium carbides; or a metal matrix composite comprising WC with at least one of Ni, Cr, Si or B.

9. (canceled)

10. (canceled)

11. (canceled)

12. A process according to claim 8, wherein the hard material comprises at least one of WC, TaNbC, or a metal matrix composite comprising at least one of WC or TaNbC, in combination with at least one of Co or Ni, optionally wherein the hard material comprises a metal matrix composite comprising at least one of WC, WC-6Co, WC-12Co, WC-6Ni or TaNbC, optionally the inner matrix material comprises a martensitic iron alloy with molybdenum boride and vanadium carbide; and the hard material comprises WC-12Co, and optionally the inner matrix material has a particle size of from 50 to 200 μm, preferably from 53 to 150 μm, and the hard material has a particle size of from 5 to 50 μm, preferably from 5 to 20 μM.

13. (canceled)

14. (canceled)

15. (canceled)

16. A process according to claim 8, wherein the hard material is deposited over the inner matrix material in locations in the deposit body which are biased towards a cutting edge or edges of the at least one cutting formation.

17. (canceled)

18. (canceled)

19. (canceled)

20. A process according to claim 1, wherein the additive deposition step includes the step of:
rotating the base substrate about said longitudinal axis to deposit tool material circumferentially on the base substrate relative to the longitudinal axis; and
providing relative movement between a tool material deposition outlet and the base substrate to deposit tool material axially on the base substrate relative to the longitudinal axis.

21. A process according to claim 1, wherein the tool material is deposited according to at least one of:
following a spiral deposition pattern around the base substrate and axially along the base substrate relative to the longitudinal axis, or
along a tool path defined to deposit in a straight line or curved line that follows the geometry of a selected cutting formation along the length of the base substrate.

22. (canceled)

23. A process according to claim 1, further including:
preheating the base substrate to at least 200° C. prior to depositing the tool material thereon,
and optionally further including the step of prior to the subtracting step of:
heat treating the base substrate and deposit body formed thereon at a temperature of 500 to 700° C., preferably between 50° and 600° C., more preferably about 550° C.

24. (canceled)

25. A process according to claim 1, wherein the deposit body is formed using at least two layers of tool material and wherein each layer is deposited with a delay of at least 1 minute, preferably at least 2 minutes, more preferably at least 3 minutes between the deposition of each subsequent deposition layer, and optionally the tool material is deposited following a material deposition track having a track width, with each adjoining material deposition track being deposited with an overlap of at least 20%, preferably at least 30%, and more preferably at least 50% of the track width.

26. (canceled)

27. A process according to claim 1, wherein the deposition step includes supplying an inert cover gas and/or an inert gas atmosphere over the base substrate during deposition of the tool material, and optionally the O₂ concentration around the workpiece during the depositing step is limited to less than 5%, preferably less than 1%, more preferably less than 0.5%.

28. (canceled)

29. (canceled)

30. A process according to claim 8, wherein the tool material is deposited onto the base substrate using a laser metal deposition process which includes a laser source which directs a laser beam onto a deposition area of the base substrate to form a melt pool therein and a powder feeding nozzle which directs the tool material into the melt pool, wherein the inner matrix material powder is fed onto the deposition surface coaxially focused into the centre of the melt pool, optionally the melt pool extends relative to the longitudinal axis ahead of and trailing behind the laser beam, and wherein the hard material powder fed onto the deposition surface at or proximate the trailing side of the melt pool (the tail end of the melt pool) with a side injection nozzle, and optionally the hard material powder is fed from in front of the laser beam, to be injected through the laser beam with a powder deposition pattern having a center located at or past the trailing side of the melt pool.

31. (canceled)

32. (canceled)

33. A process according to claim 1, wherein the subtracting step comprises a subtractive machining process to produce the shape of the at least one cutting formation and the sharp cutting edges thereon, and optionally the subtracting step comprises at least one of a: cutting, grinding, drilling, turning or milling process, preferably a grinding process.

34. (canceled)

35. (canceled)

36. (canceled)

37. (canceled)

38. (canceled)

39. A cutting tool comprising:
a base substrate having a longitudinal axis,
at least one cutting formation extending from the base substrate having a selected cutting edge configuration,
wherein each cutting formation comprises a matrix compound forming the desired shape and configuration of the cutting formation, and a hard compound located over the matrix compound forming the outer surface layer of each cutting edge,
and wherein the hard compound comprises a mixture of the matrix compound and a hard material, the hard material comprising at least one of WC, TaNbC, or a metal matrix composite comprising at least one of WC or TaNbC, in combination with at least one of Co or Ni.

40. A cutting tool according to claim 39, wherein the matrix compound includes an inner matrix material, and preferably comprises a mixture of the base substrate material and the inner matrix material, optionally the inner matrix material comprises a martensitic iron alloy with molybdenum boride and vanadium carbide; or a metal matrix composite comprising WC with at least one of Ni, Cr, Si or B, optionally the metal matrix composite comprises WC in a NiCrSiB or NiCrSiB matrix, and optionally wherein the hard material comprises at least one of WC, WC-6Co, WC-12Co, WC-6Ni or WC/TaNbC.

41. (canceled)

42. (canceled)

43. (canceled)

44. (canceled)

45. (canceled)

46. (canceled)

47. (canceled)

48. (canceled)

49. A cutting tool according to claim 39, wherein the cutting edge of the cutting tool has a hardness of at least 1000 HV_{0.5}, preferably at least 1200 HV_{0.5}, more preferably at least 1300 HV_{0.5}.

50. (canceled)

51. (canceled)

52. A process of repairing or resharpening a cutting tool that comprises at least one cutting formation having a cutting edge formed on an base substrate having a longitudinal axis, the process comprising the steps of:
additive deposition of at least one layer of a tool material comprising at least one of: tungsten carbide, TaNbC, a tungsten carbide containing alloy or composite, or a TaNbC containing alloy or composite onto at least one cutting edge of the at least one cutting formation to form a repair deposit; and
subsequently subtracting selected portions of the repair deposit body to repair or resharpen the at least one cutting formation,
optionally wherein the additive deposition process comprises at least one of: a laser metal deposition (LMD) process or a directed energy deposition (DED) process.

53. (canceled)

54. (canceled)

55. A process according to claim 52, wherein the tool material comprises a hard material which is deposited at least one cutting edge comprising at least one of WC, TaNbC, or a metal matrix composite comprising at least one of WC or TaNbC, in combination with at least one of Co or Ni, optionally the hard material comprises at least one of WC, WC-6Co, WC-12Co, WC-6Ni or TaNbC, preferably WC-12Co.

56. (canceled)

57. (canceled)

58. (canceled)

59. (canceled)

60. (canceled)

61. (canceled)

62. (canceled)

63. (canceled)

64. (canceled)

65. (canceled)
